(19) United States
(12) Patent Application Publication
(10) Pub. No.: US 2026/0098766 A1
(43) Pub. Date: Apr. 9, 2026

(54) PIEZOIONIC DEVICE FOR PRESSURE SENSING AND ENERGY HARVESTING

(71) Applicant: City University of Hong Kong, Kowloon (HK)

(72) Inventors: Derek HO, Diamond Hill (HK); Kai YANG, Kowloon (HK)

(21) Appl. No.: 18/910,842

(22) Filed: Oct. 9, 2024

(51) Int. Cl. G01L 1/16; H02N 2/18

(52) U.S. Cl. CPC G01L 1/16; H02N 2/186

(57) ABSTRACT

A piezoionic device for providing an electrical signal, wherein the device comprising: (i) a matrix comprising a plurality of mobile cations and anions, (ii) two or more electrodes in contact with the matrix, configured to provide the electrical signal in response to an external pressure applied to the matrix depending on a mobility difference between the cations and the anions. The piezoionic device comprises a selective ion mobility amplification mechanism, for selectively enhancing or hindering diffusivity of either the cations or the anions, thereby increasing the mobility difference which amplifies the electrical signal.

### TECHNICAL FIELD

The present invention relates to a piezoionic device for pressure sensing and energy harvesting. More particularly, the present invention relates to a piezoionic device for providing an amplified electrical signal in response to an external pressure. The present invention also relates to a pressure sensor, an energy harvesting device and a sensor skin comprising the piezoionic device.

### BACKGROUND

The skin is the largest organ of the human body, and is responsible for the transduction of a vast amount of sensory information. Soft cutaneous mechanoreceptors send signals to neural tissues to generate tactile sensation.

In the last decade, as driven by the advent of augmented reality (AR), virtual reality (VR), prosthetics, and soft robotics, tactile bionic technologies has been growing exponentially. Electronic skin devices that mimic the properties of human skin as well as providing superhuman functions have begun to emerge, especially for continuous health monitoring and point-of-care diagnosis applications. Nonetheless, since sensory receptors in the human skin response to external stimuli with ion flow, electronic skins that use electrons as the signal carrier are limited in achieving truly-native integration with biological systems.

Iontronic is a fast-expanding pressure and tactile sensing modality, which utilizes a signal generation mechanism based on the super capacitive nature of the electrical double layer (EDL) at the electrolyte-electrode interface. Based on this piezo-capacitive mechanism, stretchable, transparent, ionic conductors are formed which can be made softer than human tissue, thus are used to make biometric sensors that are both comfortable to wear and mechanically robust. However, such biometric sensors are in microstructures and require an external power supply for use and therefore has limited its wide-spread adoption.

Piezoionics is an emerging ionic sensing paradigm which offers soft, self-powered, and biocompatible sensing solutions. However, there are currently no rational design approaches to enhance the stimulus response of piezoionic devices. Previous reports only exploited the natural and unpronounced separation of cations and anions under an applied pressure, without explicitly enhancing the charge separation to produce an amplified piezoionic output.

### SUMMARY OF THE INVENTION

According to a first aspect of the present invention, there is provided a piezoionic device for providing an electrical signal, wherein the device comprising: (i) a matrix comprising a plurality of mobile cations and anions, (ii) two electrodes in contact with the matrix, configured to provide the electrical signal in response to an external pressure applied to the matrix depending on a mobility difference between the cations and the anions, wherein the matrix further comprises a selective ion mobility amplifier, for selectively enhancing or hindering diffusivity of either the cations or the anions, thereby increasing the mobility difference which amplifies the electrical signal.

In an embodiment, the selective ion mobility amplifier is crown ether.

In an embodiment, the crown ether is formed with Diethylene glycol bis(2-chloroethyl) ether (DGBE), Sodium Hydroxide (NaOH) and Ethyl 3,4-dihydroxybenzoate (EDB).

In an embodiment, monomers of the Diethylene glycol bis(2-chloroethyl) ether (DGBE), the Sodium Hydroxide (NaOH) and the Ethyl 3,4-dihydroxybenzoate (EDB) are with molar ratio of 1:2:1.

In an embodiment, the matrix comprises a composite selected from polyurethane (PU), polyvinylidene difluoride (PVDF), polydimethylsiloxane (PDMS), Polyvinyl alcohol (PVA), Polyacrylamide (PAM), rubber, cellulose, or a combination thereof.

In an embodiment, the composite is polyvinyl alcohol (PVA), and the matrix is formed with a crown ether grafted polyvinyl alcohol polymer (PVA-CE).

In an embodiment, the polyvinyl alcohol (PVA) and the crown ether are with a molar ratio of 1:(0.05-0.15).

In an embodiment, the matrix is in a form of a hydrogel.

In an embodiment, the matrix is stretchable to 15 times its original length.

In an embodiment, the electrodes comprise a polymer and an electrically conductive material.

In an embodiment, the polymer is polyethylene polyimide; the electrically conductive material is a metal or a carbon material.

In an embodiment, the metal is selected from any one of copper, gold, silver, platinum or a combination thereof; the carbon material is selected from any one of carbon nanotube, carbon black, graphene or a combination thereof.

In an embodiment, the electrodes are with a sheet resistance of 100Ω and a density of 0.3 g cm⁻².

In an embodiment, the device is configured to provide the electrical signal in response to the external pressure as low as 0.2 Pa.

In an embodiment, the device is configured to provide the electrical signal with a response time of 18.1 ms in response to the external pressure.

In an embodiment, the matrix is biocompatible.

According to a second aspect of the present invention, there is provided a pressure sensor comprising the piezoionic device, configured for detection of a magnitude of external pressure applied to the piezoionic device. In an embodiment, the piezoionic device comprising a plurality of electrodes aligned in an array arrangement.

According to a third aspect of the present invention, there is provided an energy harvesting device comprising the piezoionic device, configured to convert an external mechanical energy applied to the piezoionic device into electrical energy. In an embodiment, the piezoionic device comprising a plurality of electrodes aligned in an array arrangement.

According to a fourth aspect of the present invention, there is provided sensor skin comprising the piezoionic device as claimed in claim 1, wherein the piezoionic device comprises a plurality of electrodes aligned across the matrix, configured for providing a plurality of electrical signals at respective positions of the matrix in response to an external pressure applied to the respective positions, wherein the plurality of electrical signals are mapped to indicate a planar pressure change across the matrix.

In an embodiment, the plurality of electrodes are aligned in an array across the matrix.

The present invention also relates to a method of transducing mechanical energy to electrical energy (herein, energy and signal are used interchangeably, but energy and signal are typically used in contexts of energy harvesting and sensing, respectively), comprising: monitoring an electrical signal generated by redistribution of mobile ions (for example, but not limited to, the separation of cations and anions) in a piezoionic material, wherein the redistribution of mobile ions in the piezoionic volume of material (herein referred to as a “layer”) is induced by an externally applied local pressure at a portion of the layer without the application of an external signal to the piezoionic layer; and determining that the surface is pressured based on detection of the resultant electrical signal, wherein the electrical signal is monitored through at least two electrodes in contact with the piezoionic layer at different locations.

In an embodiment, the determining comprises determining that the surface is touched or influence by an external source of mechanical energy at a location near to the portion of the piezoionic layer.

In an embodiment, the electrical signal generated by redistribution of mobile ions comprises a voltage or current between a first one and a second one of the locations, the first location near the portion and the second location being spaced away from the first location.

In an embodiment, the piezoionic layer comprises a polymer or its composites.

In an embodiment, the polymer or its composites are made of synthetic (elastomer or hydrogel) materials such as polyurethane (PU), PVDF, PDMS, PVA, PAM, PAAM, or natural materials such as rubber or cellulose.

In an embodiment, the piezoionic layer comprises a liquid electrolyte for providing the mobile ions.

In an embodiment, the piezoionic layer is made of a porous solid material capable of holding the liquid electrolyte within its pores or encapsulated to prevent leakage of the liquid electrolyte.

In an embodiment, the piezoionic layer comprises a solid electrolyte for providing the mobile ions.

Further, the present invention relates to a piezoionic device comprising: a functional surface; a piezoionic layer disposed under the functional surface such that an externally applied local pressure on a portion of the sensing surface causes detectable redistribution of mobile ions in the piezoionic layer without application of an external electrical signal to the piezoionic layer;

And electrodes in contact with the layer and configured to monitor an electrical signal generated by the redistribution of mobile ions in the piezoionic layer, electrodes being made of the same material and being in contact with one side of the piezoionic layer at different locations.

In an embodiment, side of the piezoionic layer is opposite to the sensing surface.

In an embodiment, the electrodes are either integrated with the piezoionic layer in an electrode-piezoionic-electrode sandwich structure or integrated into a planner structure where the electrodes are deposited on the surface of or embedded into one side of the piezoionic layer. The electrode lateral dimension is in tens of micrometres to millimetres range and the thickness is in micrometres to centimetres range.

In an embodiment, the electrodes comprise at least one column electrode and at least one row electrode.

In an embodiment, there is no restriction to the portion of the functional surface blocked by the electrodes.

In an embodiment, the device further comprising signal processing circuits connected to the electrodes, where the circuits are configured to analyse the electrical signal and determine that the functional surface is pressured based on detection of the electrical signal. The circuits can be a combination of amplifiers, filters, level shifters, sample-and-hold, analog-to-digital converter, or a processor running software.

In an embodiment, the piezoionic layer comprises a piezoionic material.

In an embodiment, the piezoionic material can consists of a combination of materials listed in claim 5.

In an embodiment, the piezoionic layer comprises a liquid electrolyte.

In an embodiment, the piezoionic layer comprises a solid electrolyte.

In an embodiment, further comprising a piezoionic layer made of a porous solid material capable of holding the liquid electrolyte within its pores or encapsulated to prevent leakage of the liquid electrolyte.

In an embodiment, the device is a film.

The present invention further relates to a method of sensing a pressure applied to a surface, comprising: monitoring an electrical signal generated by redistribution of mobile ions in a piezoionic layer under the surface, wherein the redistribution of mobile ions in the piezoionic layer is induced by an externally applied local pressure at a portion of the layer; and determining that the surface is pressured based on detection of the electrical signal, wherein the electrical signal is monitored through at least two electrodes in contact with one side of the piezoionic layer at different locations, the at least two electrodes being made of the same material.

The present invention further relates to a piezoionic sensor comprising: a sensing surface; a piezoionic layer disposed under the sensing surface such that an externally applied local pressure on a portion of the sensing surface causes detectable redistribution of mobile ions in the piezoionic layer; and electrodes in contact with the layer and configured to monitor an electrical signal generated by the redistribution of mobile ions in the piezoionic layer.

The present invention further relates to a piezoionic energy harvester comprising: a piezoionic layer such that an externally applied local pressure causes detectable redistribution of mobile ions in the piezoionic layer; and electrodes in contact with the layer and configured to monitor an electrical signal generated by the redistribution of mobile ions in the piezoionic layer.

In an embodiment, the piezoionic energy harvester comprising energy processing circuits connected to the electrodes, where the circuits are configured to analyse the electrical energy output from the device to determine whether or not energy conversation occurs and to process the device output energy into a form suitable for the load or further downstream circuits.

An embodiment of the present invention introduces the use of a selective ion mobility amplifier matrix of a piezoionic device to amplify the electrical signal generated by the device upon application of an external pressure. By making the electrical signal stronger and easier to detect, the piezoelectric device of the present invention has a more versatile use in everyday life.

In practice, when the piezoionic device is used as a pressure sensor, it has a higher sensitivity, speed, stability and dynamic range than conventional devices in terms of sensing pressure. Further, since the piezoionic device of the present invention is capable of self-power generation, it does not require a power source to operate, thus eliminating the weight and cost burden of providing and replacing the power source of the device. These improved features of the piezoionic device of the present invention make it suitable for use as a sensor skin.

### BRIEF SUMMARY OF THE FIGURES

The invention will be described by way of reference only, with respect to the accompany figures. The figures presented herein may not be drawn in scale and any reference to dimensions in the drawings or the following description is specific to the embodiments disclosed.

FIG. 1a is a schematic diagram of an embodiment of a piezoionic device according to the present invention;

FIG. 1b is a schematic diagram showing reactions of a selective ion mobility amplifier with mobile ions in the piezoionic device of FIG. 1a;

FIG. 1c shows an enlarged portion of a matrix of the piezoinonic device of FIG. 1a;

FIG. 1d is a diagram demonstrating a cascade of electronic amplifiers in electronic circuits;

FIG. 2a shows a synthetic route of a crown ether (CE) grafted polyvinyl alcohol (PVA-CE);

FIG. 2b is a proton nuclear magnetic resonance (NMR-H) spectrum of crown ether (CE), polyvinyl alcohol (PVA) and crown ether grafted polyvinyl alcohol (PVA-CE);

FIG. 2c shows classification of ion pairs in a NaCl solution into contact with ion pairs (CIPs), solvent-shared ion pairs (SIPs), solvent-separated ion pairs (SSIPs), and ion aggregates;

FIG. 3 is a carbon-13 nuclear magnetic resonance (NMR-C) spectrum of CE, PVA and PVA-CE;

FIG. 4 is a graph showing Fourier transform infrared spectra of monomers and products of CE, PVA and PVA-CE;

FIG. 5 shows Fourier transform infrared spectra of PVA-CE gel with different CE contents;

FIG. 6a shows x-ray diffraction (XRD) data of PVA and PVA-CE polymer;

FIG. 6b shows a tensile stress-strain curve of PVA and PVA-CE with different crosslinker contents, and photographic representations of PVA and PVA-CE gel;

FIG. 6c is a table showing mechanical properties of PVA and PVA-CE with different crosslinker contents;

FIG. 7a shows molecular dynamics (MD) simulations models of PVA and PVA-CE gel without applied pressure;

FIG. 7b is a graph showing radial distribution function (RDF) of Na⁺—H₂O in PVA and PVA-CE;

FIG. 7c is a graph showing radial distribution function (RDF) of Na⁺—Cl⁻ in PVA and PVA-CE;

FIG. 7d shows graphs of radial distribution functions (RDF) of Na⁺—Cl− and coordination number of water for system without applied pressure in PVA and PVA-CE;

FIG. 7e shows MD simulation models of PVA and PVA-CE under pressure;

FIG. 7f is a table showing piezoionic effect of PVA-CE 7% under different pressures;

FIG. 7g shows an electrochemical impedance spectroscopy (EIS) of PVA-CE gel with different CE contents, magnified curves of EIS at the high-frequency region, and calculated ionic conductivities by EIS;

FIG. 7h is a graph showing diffusivity difference between Na⁺ ions and Cl− ions with respect to time;

FIG. 8 is a graph showing mean squared displacement (MSD) and calculated diffusivity of PVA and PVA-CE gels for system without applied pressure;

FIG. 9 shows graphs indicating mean squared displacement (MSD) and calculated diffusivity of PVA and PVA-CE gels for system under applied pressure;

FIG. 10 is a diagram showing electrostatic potential of a CE molecule and numerical values of the electrostatic potential extreme points on a surface of the CE molecule;

FIG. 11 shows graphs indicating radial distribution function (RDF) of Na+/Cl− ions and coordination number of PVA gel and PVA-CE gel for system under applied pressure;

FIG. 12 is a graph showing radial distribution function (RDF) differences of Na⁺—H₂O between PVA gel and PVA-CE gel for system under applied pressure;

FIG. 13 shows schematic diagrams and photographic representations of an embodiment of an electrode, a PVA-CE sensor, a PVA and PVA-CE piezoionic device according to the present invention;

FIG. 14 is a schematic diagram showing an electromechanical characterisation setup for measuring piezoionic output of the piezoionic device of FIG. 13;

FIG. 15a is a schematic diagram showing an indentation test setup with pressure being applied to the PVA-CE gel of an embodiment of a piezoionic device according to the present invention;

FIG. 15b shows graphs demonstrating step and impulse responses at 10 kPa for PVA and PVA-CE;

FIG. 15c is a graph showing PVA and PVA-CE gel voltage response upon tap compression at 10 kPa;

FIG. 15d shows graphs demonstrating sensing performance of PVA-CE with different CE contents upon a hold compression at 10 kPa;

FIG. 15e is a graph showing piezoionic coefficients of the piezoionic device of FIG. 15a with respect to applied pressure;

FIG. 15f shows compressive stress-strain curves of the PVA-CE gel of FIG. 15a;

FIG. 15g is a graph showing responses of the piezoionic device of FIG. 15a from five successive drops of water, with each drop exerting a pressure of 4 Pa;

FIG. 15h shows graphs demonstrating the output voltage of medical monitoring of a radial artery pulse using the piezoionic device of FIG. 15a as a pressure sensor;

FIG. 15i is a graph showing cycling response of the PVA-CE gel of FIG. 15a;

FIG. 16 shows graphs demonstrating sensing performance of a piezoionic device according to an embodiment of the present invention, with different CE contents upon tap compression for different pressure ranges;

FIG. 17 is a graph showing piezoionic coefficients for different pressure ranges of PVA-CE piezoionic devices with different CE contents;

FIG. 18 shows graphs demonstrating voltage response stability of a PVA-CE peizoionic device with 4% and 7% CE contents under cycling test;

FIG. 19 is a graph showing dehydration shape memory test results which reflects the performance of the PVA-CE piezoionic device recovering fully upon rehydration;

FIG. 20 shows photographic representations of dehydration and rehydration of an embodiment of a PVA-CE piezoionic device according to the present invention;

FIG. 21 is a graph showing cycling voltage response of a PVA-CE gel of an embodiment of a piezoionic device according to the present invention after rehydration;

FIG. 22 is a table showing detect limits, response time and self-power ability of different ionic mechanical sensors;

FIG. 23a shows photographic representations of an embodiment of a piezoionic device according to the present invention, with 2×2 and 1×6 electrode array configurations;

FIG. 23b is a graph showing electrical responses of the piezoionic device with 2×2 electrode array configuration of FIG. 23a;

FIG. 23c shows a photographic representation of a 2×2 electrode array piezoionic skin and a graph showing electrical responses of the piezoionic device collected by different electrodes;

FIG. 23d a graph showing electrical responses of the piezoionic device with 1×6 electrode array configuration of FIG. 23a;

FIG. 23e shows a schematic diagram and a photographic representation of an embodiment of a sensor skin according to the present invention, which comprises a piezoionic device with 6×6 electrode array;

FIG. 23f shows a photographic representation of the 1×6 electrode piezoionic device of FIG. 23c, and the electrical response outputs collected via each of the electrodes;

FIG. 23g shows a photographic representation of a 6×6 electrode piezoionic device used in the sensor skin of FIG. 23e, and a schematic diagram showing connections of an electromechanical characterization setup of the piezoionic device; and

FIG. 23h shows photographic representations and corresponding voltage maps of the sensor skin of FIG. 23e upon sensing a single touch, multiple touches, and a pinch.

### DETAILED DESCRIPTIONS OF THE EMBODIMENTS

In an embodiment of the present invention, a strategy for enhancing the pressured-induced voltage response in ionic hydrogels is provided, which utilises crown ether as selective ion mobility amplifiers for enhancing the pressured-induced voltage response in ionic polyvinyl alcohol (PVA) hydrogels.

This strategy enhances the electrical signal generated by the redistribution of mobile ions in the hydrogel, thus improving the pressure detection limit and sensitivity. The crown ether grafted PVA (PVA-CE) sensor exhibits an ultra-low pressure detection limit of 0.2 Pa with a fast response time of 18.1 ms. Profiting from these properties, a human somatosensory network analogous PVA-CE piezoionic skin is demonstrated using arrayed pressure sensing, which are capabilities highly promising for emerging healthcare applications such as synthetic biology, soft robotics, and beyond.

The prototyped PVA-CE hydrogel achieves a 30-fold amplified piezoionic coefficient of 1490 nV Pa⁻¹ within 0-1 kPa, compared to 49 nV Pa⁻¹ of unmodified PVA. The PVA-CE exhibits an ultra-low pressure detection limit of 0.2 Pa with a fast response time of 18.1 ms. Profiting from these properties, the piezoionic device can form a human somatosensory network analogous PVA-CE piezoionic skin using arrayed pressure sensing, which are capabilities highly promising for emerging healthcare applications such as synthetic biology, soft robotics, and beyond.

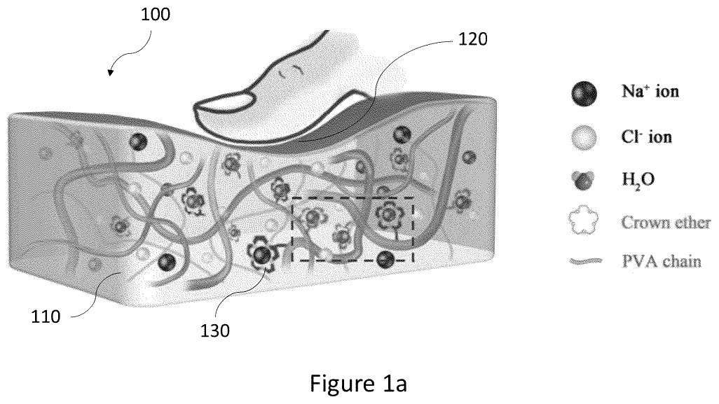

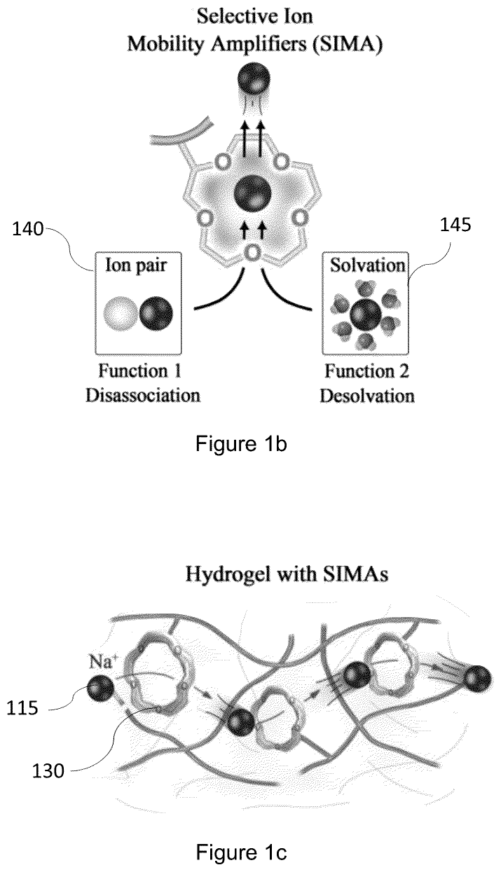

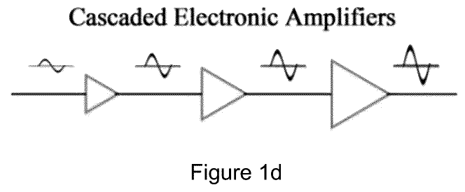

FIG. 1a shows an embodiment of a piezoionic device 100 according to the present invention. The piezoionic device 100 comprising a matrix 110 which contains a plurality of mobile ions dissolved in water, such that upon an application of a pressure 120 to a surface of the matrix 110, an electrical signal is produced across the electrodes (not shown in the figure). The electrical signal is amplified by the presence of the selective ion mobility amplifiers 130 in the matrix, which in this embodiment is crown ether, such that the output electrical signal can be easily detected for use as a pressure sensor which senses pressure and strain.

In an embodiment, the piezoionic device is used for mechanical energy harvesting. The piezoionic energy is applicable on human bodies, for example for producing energy from body movements, beating of the heart. The piezoionic device is also used for harvesting energy from waves, wind, vibration of buildings.

In an embodiment, the piezoionic device is applied for use in soft robotics array pressure sensing skin.

As shown in FIG. 1b, Crown ether (CE) effectively performs two functions: (1) dissociation of ion pairs 140, and (2) desolvation of ions 145, resulting in the promotion of ion diffusion kinetics. As a result, referring to FIG. 1c, the diffusivity of Na+ ions 115 can be selectively enhanced through the electrostatic interaction between the crown ethers 130 and the Na⁺ ions 115, which amplifies the mobility difference between Na+ and Cl−, thereby amplifying the piezoionic effect. This is analogous to a cascade of electronic amplifier commonly used in microelectronic circuits and long-distance communication links, as illustrated in FIG. 1d.

To assess application potential, a piezoionic sensor skin is realized using a version of the PVA-CE hydrogel with an ion concentration selected to closely match that of the human skin to maximize biocompatibility. The piezoionic device of the present invention achieves self-power generation, large piezoionic output, large-area scalability, rehydration shape memory, and high biocompatibility that enable the proposed amplification strategy implemented in PVA-CE to serve a variety of biomedical applications such as ionic skins, soft robotics, and beyond.

### SYNTHESIS AND CHARACTERIZATION OF PIEZOIONIC HYDROGELS

### a) Chemicals

Diethylene glycol bis(2-chloroethyl) ether (DGBE), Ethyl 3,4-dihydroxybenzoate (EDB), Dimethyl sulfoxide (DMSO), NaOH, Methanol, Polyvinyl alcohol (PVA 1799), N-methylpyrrolidone (NMP), Tetrabutylammonium bromide, Sodium chloride, Boric acid, Triethanolamine, Acetone, and Glycerine were purchased from Shanghai Macklin Biochemical Co., Ltd.

### b) Synthesis of Ester Group Modified 15-Crown-5 (CE)

The monomers of Diethylene glycol bis(2-chloroethyl) ether (DGBE), NaOH and Ethyl 3,4-dihydroxybenzoate (EDB) with a molar ratio of 1:2:1 and solvent DMSO were mixed in a 3-neck-boiling-flask with a reaction in an 80° C. oil bath for 72 h. After purification, the solvent was distilled off under reduced pressure. Finally, ester group modified 15-crown-5 (CE) was obtained. The calculated yield was 52.4%.

### c) Synthesis of 15-Crown-5 (CE) Grafted PVA Polymer (PVA-CE)

The PVA-CE polymer was obtained by grafting CE on the PVA chain through transesterification reaction. Specifically, PVA1799 and CE with a molar ratio of 1:(0.05-0.15) were added into a three-necked flask, the solvent was N-methyl pyrrolidone. The catalyst was tetrabutylammonium bromide. The reaction temperature was 160° C. with the 4 h reaction time using the backflow under reduced pressure. After that, the solvent was distilled off under reduced pressure.

### d) Synthesis of PVA-CE Ionic Hydrogel

The PVA-CE gel was prepared by the traditional freeze-thaw method. The mold was frozen at −10 to −40° C. for about 24 h, then thawed at 25° C. for 1 to 3 h. The process was repeated several times to form a physically cross-linked PVA-CE hydrogel. Finally, PVA-CE hydrogel was soaked in 2M NaCl solution for 24 h to obtain PVA-CE piezoionic hydrogels.

### e) Synthesis of the Borate Ester Crosslinker

The borate ester crosslinker was synthesized by a one-step esterification reaction. Specifically, boric acid, triethanolamine and glycerine with a mass ratio of 1:4:2 were added into a three-necked flask for a reaction in a 140° C. oil bath for 3 h. Afterwards, the product of the previous step was diluted forty times with water to obtain the borate ester crosslinking agent.

Amplification of the piezoionic effect can be realized through enlarging the difference in mobility between anions and cations. In an ionic hydrogel, piezoionic amplification can be achieved through modifying the polymer matrix to either selectivity helps or hinders ions. To realize this concept in a PVA hydrogel, the 15-crown-5 crown ether was designed, synthesized, and grafted onto the polyvinyl alcohol polymer to form the PVA-CE sample. The 15-crown-5 configuration was purposefully selected to molecular-diameter match the CE and the Na⁺ ion.

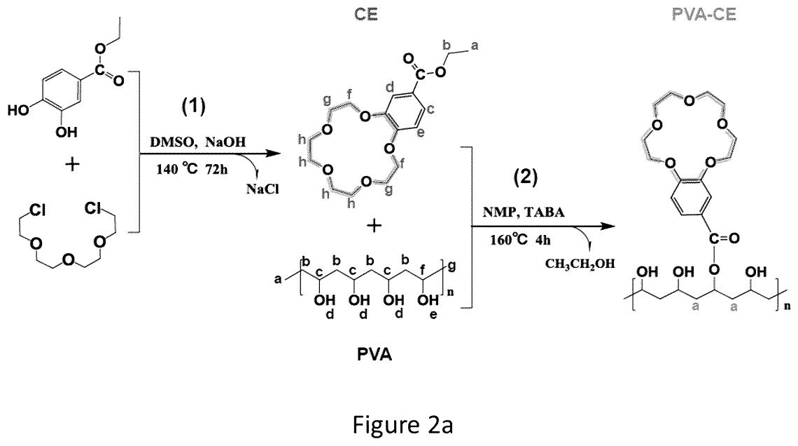

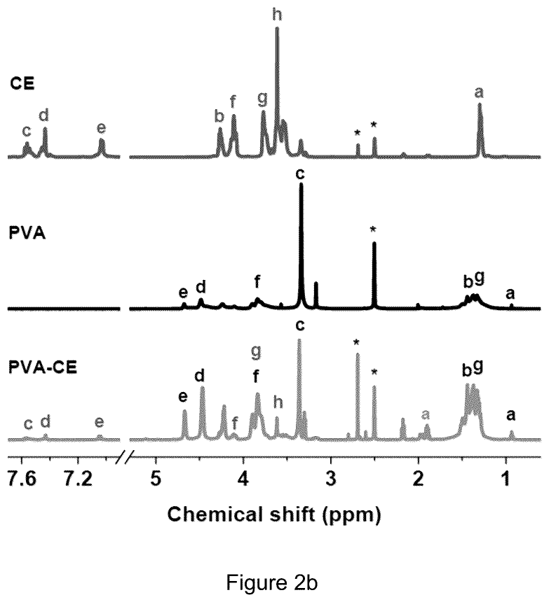

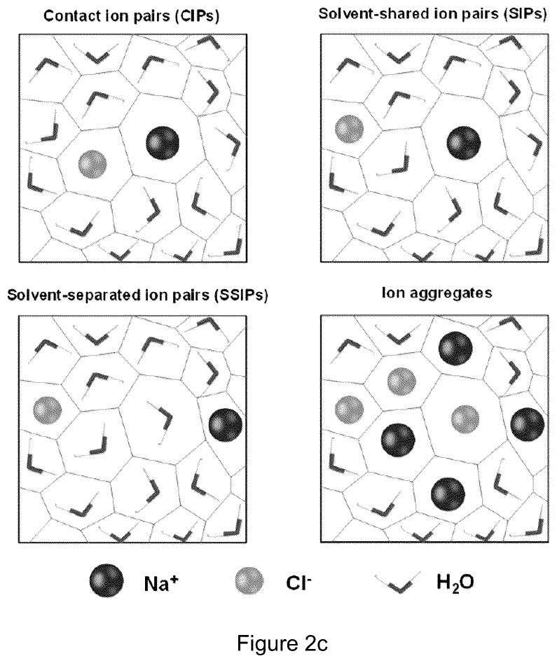

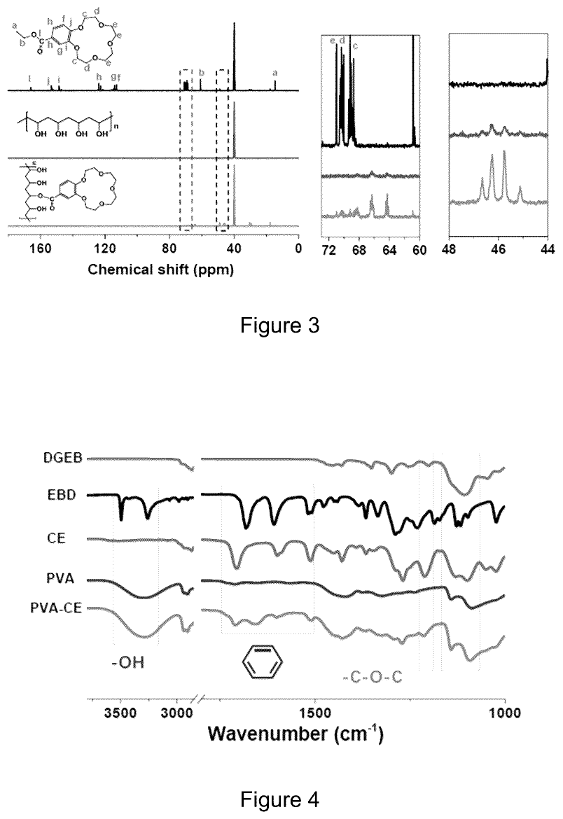

FIG. 2a shows a synthetic route of PVA-CE which consists of two steps: (1) Williamson reaction and (2) transesterification. Nuclear magnetic resonance spectroscopy (NMR) was used to confirm the feasibility of this reaction route, as demonstrated by FIG. 2b, which shows a proton nuclear magnetic resonance (NMR-H) spectrum of crown ether (CE), polyvinyl alcohol (PVA) and crown ether grafted polyvinyl alcohol (PVA-CE). FIG. 3 shows a carbon-13 nuclear magnetic resonance (NMR-C) spectrum of crown ether (CE), PVA and PVA-CE, the structure of CE is reflected by the 1H-NMR, 1H NMR (600 MHZ, DMSO) δ: 7.56 (dd, J=10.3, 9.7 Hz 1H, site c), 7.45 (d, J=12.8 Hz 1H, site d), 7.09 (dd, J=8.4, 3.4 Hz 1H, site e), 4.26 (m, 2H, site b), 4.10 (m, 4H, site f), 3.76 (m, 4H, site g), 3.51 (s, 8H, site h), 1.30 (t, J=7.2, 2.4 Hz, 3H, site a), and 13C-NMR spectra. The collected 1H-NMR signal showed various specific H peaks of PVA (δ: a. 0.94, b. 1.44, c. 3.34, d. 4.49, e. 4.68, f. 3.84, g. 1.37, black) and the specific H peaks of CE (δ: c. 7.56, d. 7.45, e. 7.09, f. 4.10, g. 3.76, green), confirming that the compound was indeed PVA-CE. The disappearance of the —CH₃ (δ: a. 1.30, green) and —CH₂—(δ: b. 4.26, green) H peaks of CE and the appearance of the H peak at the PVA-CE grafting site (δ: a. 1.90, black) indicated that CE was successfully grafted on the PVA chain.

The structure and reaction process of the above-mentioned molecular compounds were also confirmed by Fourier transform infrared spectroscopy (FTIR) as shown in FIG. 4. Using a conventional freeze-thaw method, a range of PVA and PVA-CE gels were prepared and soaked with 2M NaCl. Binding between CE and Na⁺ ions in a solution was due to the match of physical dimensions (Na⁺ ion diameter: 204 pm, CE hole diameter: 170˜220 pm).

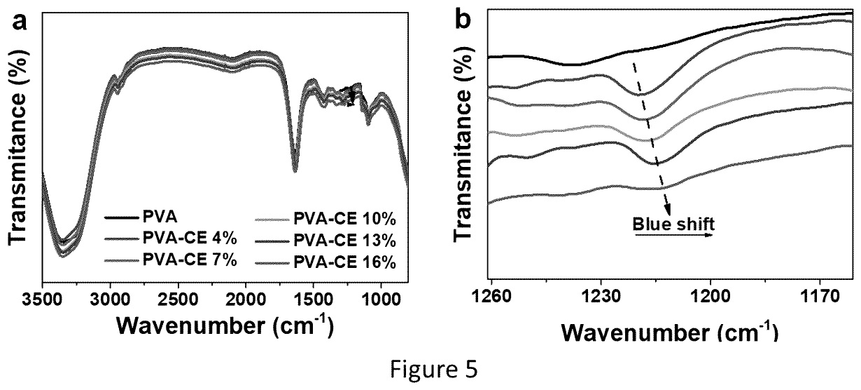

Referring now to FIG. 5 which shows a Fourier transform infrared spectra of PVA-CE gel with different CE contents, it is shown that the characteristic peaks of the ether bonds appeared blue-shifted (1220 to 1214 cm⁻¹) with the increase of the molar content of CE (4% to 16%) in PVA-CE. This could be attributed to the formation of [Na⁺(CE)] complexes that weaken the cation-anion interactions, thus the peak of the ether bonds shifted to lower wavenumbers due to the increased number of complexes. Moreover, the [Na⁺(CE)] complex could also weaken the ion-solvent interaction.

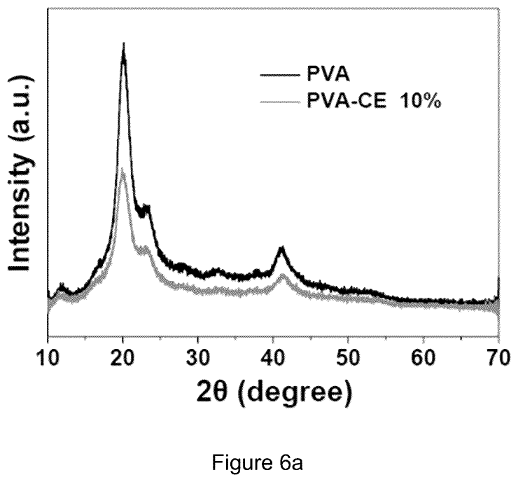

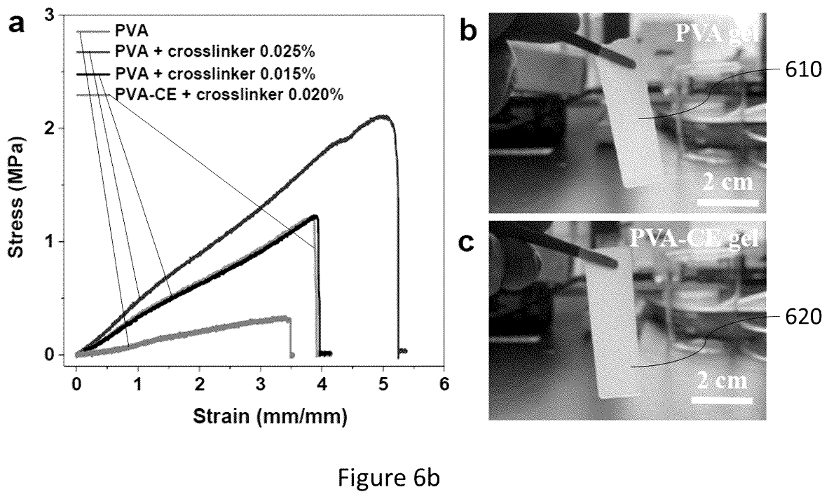

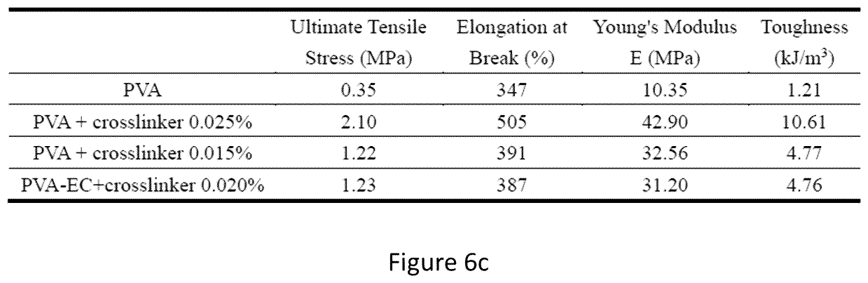

The introduction of CE reduced the crystallinity. This is shown in FIG. 6a which provides the x-ray diffraction (XRD) data of PVA and PVA-CE polymer, and the amount of hydroxyl groups of PVA, resulting in the mechanical strength of PVA-CE decreasing with respect to increasing CE content. In order to decouple the effect of mechanical property and the effect of crown ether ion selective amplification on piezoionic output, a borate ester crosslinker was used to normalize the mechanical property of the PVA and PVA-CE samples to the same Young's modulus. A tensile stress-strain curve of PVA gel 610 and PVA-CE gel 620 with different crosslinker contents is shown in FIG. 6b, and the corresponding mechanical properties of the PVA gel 610 and PVA-CE gel 620 is illustrated in the table of FIG. 6c. Specifically, PVA with 0.015 wt % crosslinker exhibits an ultimate tensile stress (1.22 MPa), elongation at break (390%), Young's modulus E (0.32 MPa), toughness (2.45 MJ m⁻³), which match the parameters from PVE-CE with 0.020 wt % crosslinker (1.23 MPa, 390%, 0.32 MPa, 2.45 MJ m⁻³).

### Methods for Designing and Fabricating Piezoionic Devices

### a) Preparation of CNT/PE Electrodes

The electrodes are formed by mixing a polymer film with an electrically conductive material. In an embodiment, the electrically conductive material includes a metal and a carbon material. The metal is selected from any one of copper, gold, silver, platinum or a combination thereof, and the carbon material is selected from any one of carbon nanotube, carbon black, graphene or a combination thereof.

In an embodiment, the electrodes are a mixture of carbon nanotube and polyethylene polyimide (CNT/PE electrodes).

CNT/PE electrodes were prepared by patterning CNT/PE film using laser. Specific parameters: Sheet resistance=100Ω Thickness=0.01 cm Density=0.3 g cm⁻².

### b) Preparation PVA-CE Piezoionic Devices

The PVA-CE polymer was dissolved in DI water with a mass fraction of 15 wt %, with a range of 0.01-0.025 wt % borate ester crosslinkers, then put into an oven at 60° C. for half an hour until fully mixed. The mixed solution was introduced into the round mold (diameter: 1.5 cm height: 0.2 cm) and, in order to obtain low contact resistance, the CNT/PE electrodes were mounted before cooling. Afterwards, using freeze-thaw method obtain PVA-CE piezoionic devices.

### c) Preparation of PVA-CE Piezoionic Ionic Skin Devices

PVA-CE piezoionic ionic skin: Using 15 wt %, PVA-CE aqueous solution with 0.5 wt % borate ester crosslinker are put into an oven at 60° C. for half an hour until fully mixed. The mixed solution was introduced into the square mold (length: 5 cm, width: 5 cm, height: 0.1 cm). After a freeze-thaw cycle, the PVA-CE hydrogel was soaked in 2M NaCl for 24 h. Electrode array: The electrode array was prepared by printing copper on PE elastic film. The contact points were gold-plated and exposed, and the rest were insulated from the package. Ionic skin device: Carbon black glue was applied to the contact point surface of the electrode array. Then, the electronic skin was pasted on the surface of the electrode array and encapsulated with a PE ultra-thin elastic film. The samples were allowed to rest for 24 h for the bond to stabilize before characterization.

### Methods of Testing Piezoionic Performance

### a) Force Testers and Configuration

A Mark 10 series F+intelliMESUR® advanced tension/compression force testers with force gauge (model M5-5) as a force provider. The piezoionic devices was fixed on a glass slide and encapsulated with PI elastic film, and then the CNT/PE electrode was connected to the wire for electrical signal testing.

### b) Indentation Conditions

The electrode surface of the gel was placed at the bottom to avoid signal interference caused by electrode vibration and displacement. Samples were indented using a 1 cm diameter cylinder with an indenter at up to 50 mm/min indentation speed, and ensure that the centre of the stressful application region was opposite to the centre electrode of the gel.

### c) Data Collection System

Each sample was subjected to a sinusoidal compression to determine the amplitude and the phase of the voltage generated, which was measured with the Keithley DAQ6510 data acquisition/multimeter system. The Mark 10 pressure signal and the Keithley electrical signal were connected to and controlled by a PC using MATLAB software to achieve synchronization of signal acquisition.

### The Simulations of Ionic Diffusion Behaviour in Piezoionic Hydrogel

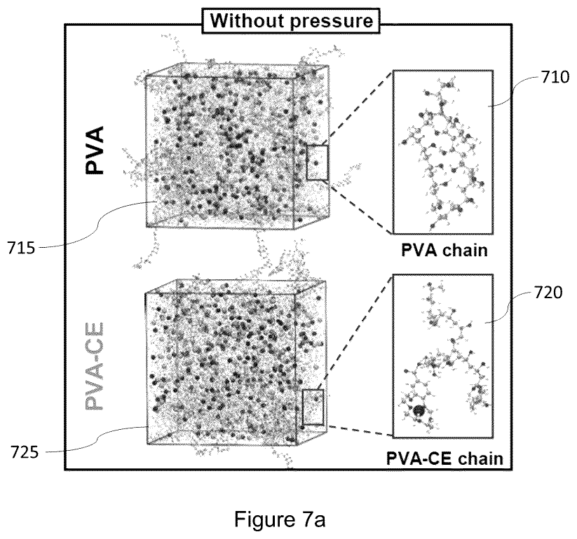

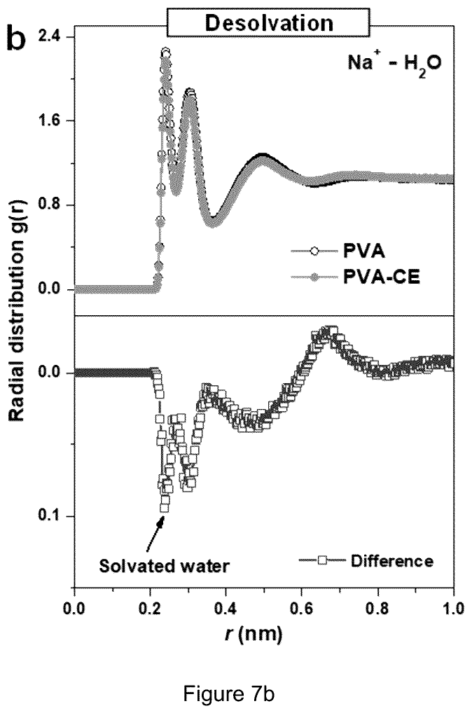

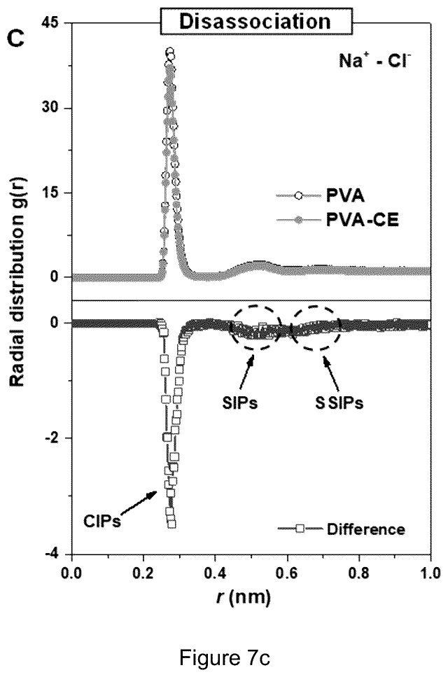

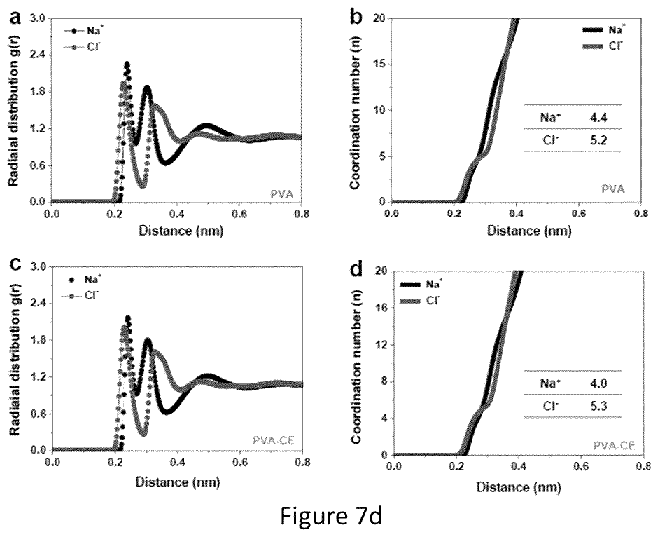

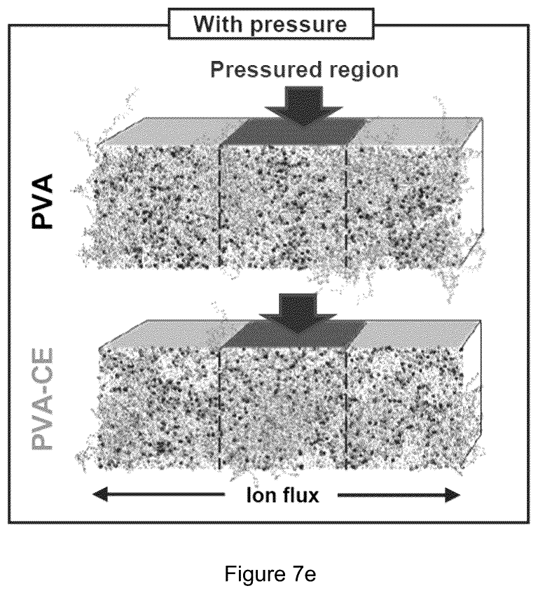

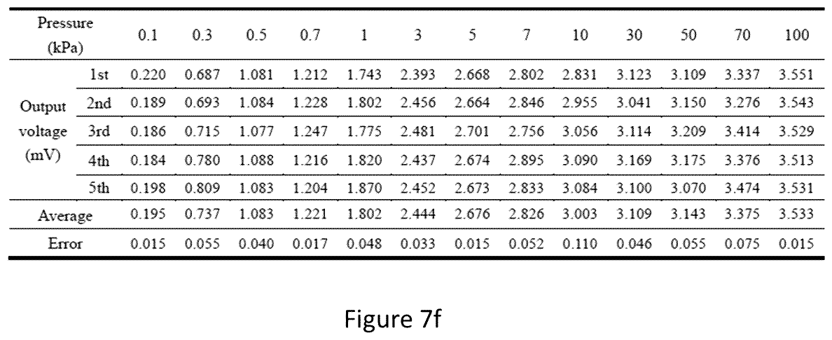

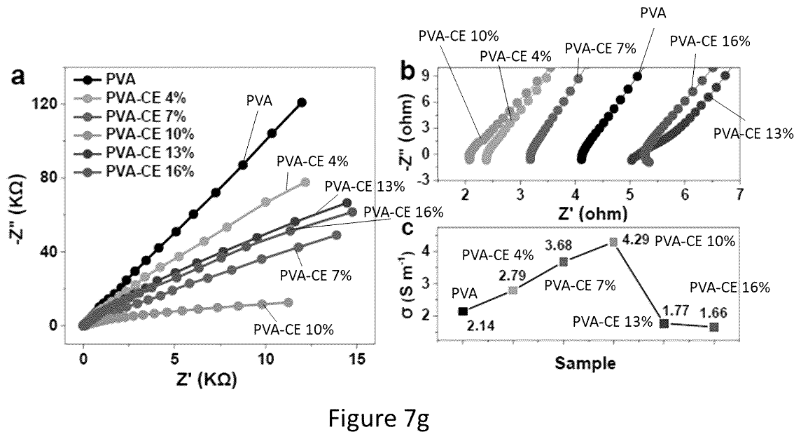

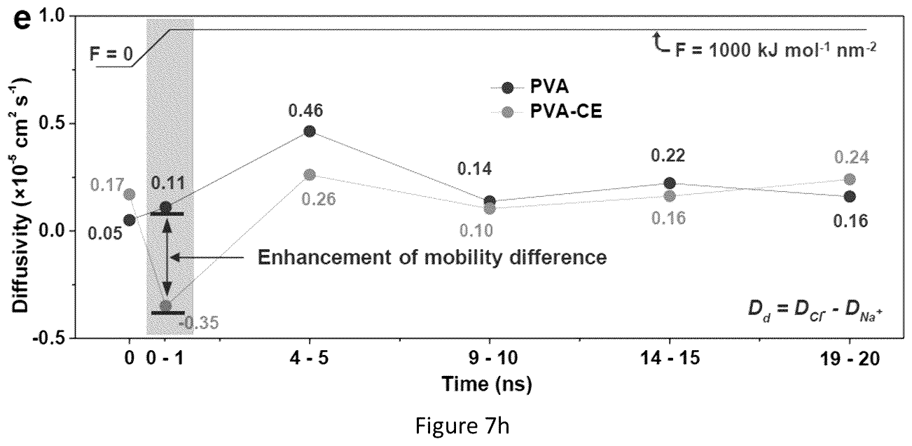

Quantum chemistry simulations were performed to study ion dynamics in hydrogel systems under different conditions. Firstly, molecular dynamics (MD) simulations were used to model the PVA and PVA-CE hydrogels for the case without any applied pressure. As shown in FIG. 7a, the distribution of the PVA chains 710, Nat cations and CI-anions in the PVA gel 715 was made random initially, with no interaction in the form of chemical bonds. In contrast, the [Na⁺(CE)] complex 720 with coordinate covalent bond was clearly detected in the PVA-CE gel system 725.

Due to the diameter match that enabled selective interaction between CE and Na+ ions, CE effectively performs two functions: (1) dissociation of ion pairs (i.e. the breaking of Na⁺—Cl⁻ ion pairs to single Na⁺ and Cl⁻ ions), and (2) desolvation of ions (i.e. the stripping of solvated water molecules around Na⁺ ion). FIG. 7b shows the radial distribution function (RDF) of Na⁺—H₂O in PVA and PVA-CE. The radial distribution function (RDF) can be used to study the effect of CE on the ion pairs and the solvated Na⁺ ions. FIG. 7c and FIG. 2c show the pair correlation statistical functions of Na⁺—Cl⁻ ion pair in PVA and PVA-CE. In particular, FIG. 2c shows the classification of ion pairs in a NaCl solution into contact ion pairs (CIPs), solvent-shared ion pairs (SIPs), solvent-separated ion pairs (SSIPs), and ion aggregates.

The first peak of g(r) mainly come from contact ion pairs (CIPs, r≈0.27 nm). The points where the solvent-shared ion pairs (SIPs) and solvent-separated ion pairs (SSIPs) begin to contribute to g(r) are at r≈0.52 nm and r≈0.70 nm, respectively. After a Gaussian fit and taking an area integral, results show that PVA-CE has a 8.7% reduction in CIPs, a 9.1% reduction in SIPs, and a 9.1% reduction in SSIPs, with respect to the pristine PVA. In contrast, the solvated water of the Nat ions in PVA-CE is reduced by 4.2%, as calculated from the simulation model of FIG. 7e and the information listed in the table of FIG. 7f. This result indicates a high ionicity (1−Δ), where Δ represents a deviation from Kohlrausch's law, of the Na⁺ and Cl⁻ ions in PVA-CE. Ionicity is defined as a ratio of the total conductivity (κ, actual ionic conductivity) to the Nernst-Einstein conductivity:

$$( {\sum }_{I} {κ}_{I}^{( 1 )} , ideal ionic conductivity ) , \qquad ( 1 )$$

$$1 - Δ = \frac{κ}{{\sum }_{l} {κ}_{l}^{( 1 )}} .$$

According to equation (1), PVA-CE with Na⁺ ion selective diffusion governing its electrical behaviour exhibits a high ion conductivity. This is evident from impedance spectroscopy (EIS) data shown in FIG. 7g. Results indicate that the highest ionic conductivity of PVA-CE (4.29 S m⁻¹) is twice that of PVA (2.14 S m⁻¹), suggesting that the dissociation and desolvation effects of the CE group in PVA-CE promote ion diffusion kinetics.

As the piezoionic output is caused by pressure-induced directional fluidic flow, it is critical to understand the kinetics of ion diffusion when a gel is under pressure. In the model, as shown in FIG. 7h which shows the diffusivity difference between Na⁺ ions and Cl⁻ ions with respect to time. The hydrogel unit cell is instantiated three times along the direction of flow. The middle unit is subjected to a force constant of 1000 KJ mol⁻¹ nm⁻². Mean squared displacement (MSD) has been used to calculate diffusivity (D) at different points in time using the well-adopted Einstein's relation, given by

$${D}_{i} = \frac{1}{6} {lim}_{t \to ∞} \frac{d}{dt} 〈 {\vert {r}_{i}^{c} ( t ) - {r}_{i}^{c} ( 0 ) \vert}^{2} 〉 , \qquad ( 2 )$$

where

$${r}_{i}^{c} ( t )$$

is the location of the centre of mass of ion (i) at time (t).

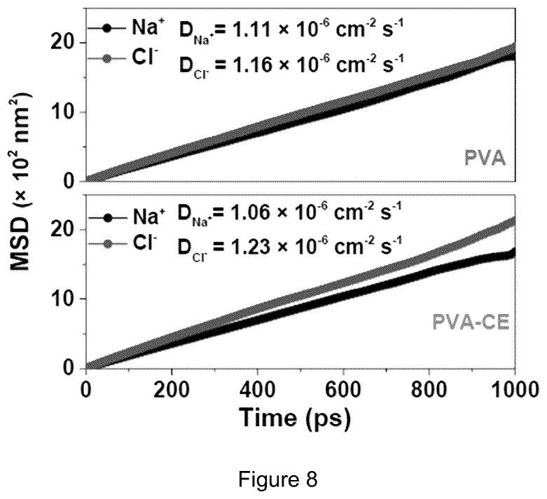

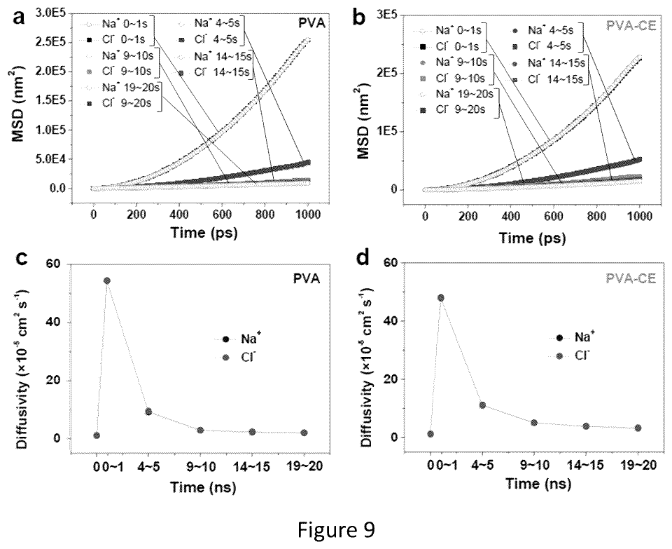

Before the application of pressure (t=0 ns), ions are dominated by self-diffusion (i.e., Brownian motion). To quantify the ionic gradient, the diffusivity difference between cations and anions, i.e., D_{d}=D_{cl-}−D_{Na+}, is computed. In PVA, D_{d} for Cl⁻ ions (1.16×10⁻⁵ cm² s⁻¹) and Na⁺ (1.11×10⁻⁵ cm² s⁻¹) is 0.05×10⁻⁵ cm² s⁻¹ as shown in the graph of FIG. 8, which is contributed by the size differences between the solvated cation (Na⁺≈0.358 nm) and anion (Cl⁻≈0.181 nm). In contrast, in PVA-CE, D_{d} for Na⁺ (1.06×10⁻⁵ cm² s⁻¹) and Cl⁻ ions (1.23×10⁻⁵ cm² s⁻¹) increases to 0.17×10⁻⁵ cm² s⁻¹, which is due to the reduced Brownian motion of Na+ ions in the [Na⁺(CE)] complex. The piezoionic dynamics with respect to time for the system under an applied pressure is then examined. Initially, at (t=0˜1 ns), i.e. statistics are collected for a 1 ns time period, ions are dominated by water-driven diffusion up to a maximum water flux J, as shown in FIG. 9 which shows graphs indicating mean squared displacement (MSD) and calculated diffusivity of PVA and PVA-CE gels for system under applied pressure.

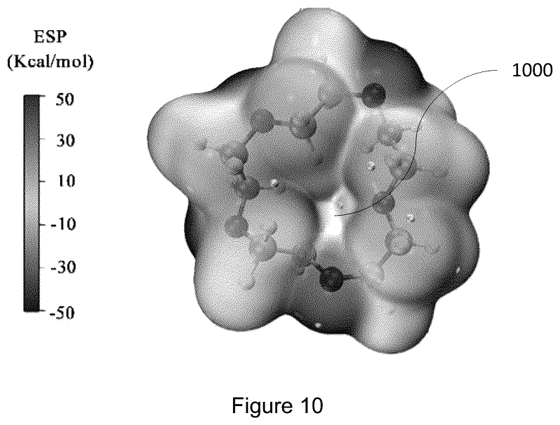

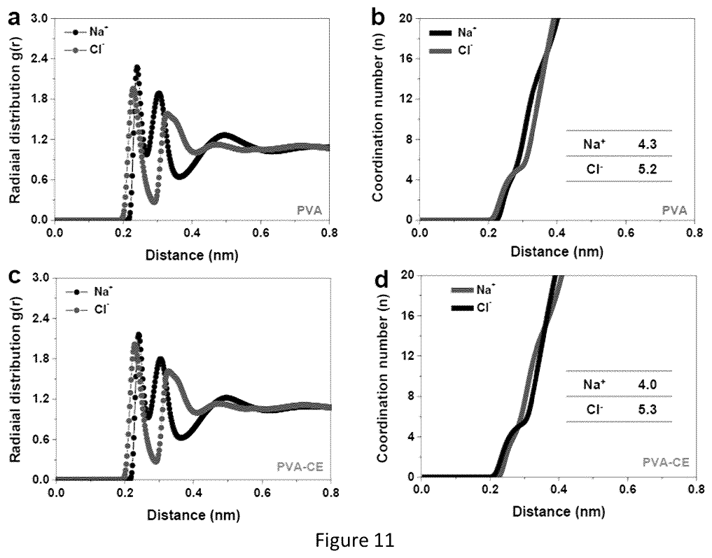

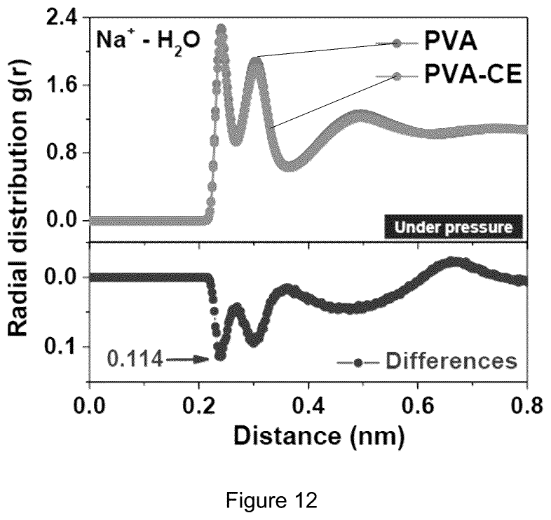

In PVA, the maximum ionic diffusivities are 54.4×10⁻⁵ cm² s⁻¹ (Cl⁻) and 54.3×10⁻⁵ cm² s⁻¹ (Na⁺), respectively, and Dd is 0.11×10⁻⁵ cm² s⁻¹. In contrast, for PVA-CE, the maximum ionic diffusivities are 47.8×10⁻⁵ cm² s⁻¹ (Cl⁻) and 48.1×10⁻⁵ cm² s⁻¹ (Na⁺) respectively, which produce a Dd of −0.35×10⁻⁵ cm² s⁻¹. This indicates that, driven by water flux, the CE group exhibits the selective transport of Na⁺ ions, resulting in a greater diffusivity of Na⁺ than that of Cl⁻ ion. The electrostatic potential (ESP) further revealed the electrostatic interaction between the ions and the CE groups. As shown in FIG. 10, the centre 1000 of the CE molecule is weakly electronegative, with an ESP value of −4.6 Kcal mol⁻¹. When water flow drives ion diffusion, the selective diffusion of Na+ ions under the influence of CE is assisted by Coulomb interaction, as illustrated in the graphs of FIG. 11 and FIG. 12.

In addition, as a second function of CE, desolvation reduces the size of the Na⁺ ions to r≈0.204 nm, thereby improving their transport. As a result, due to the two functions of CE, the diffusivity of Na⁺ ions are significantly greater than that of Cl⁻ ions in the PVA-CE sample.

According to Darcy's Law, Gennes and Anne d'Albis, the peak voltage (ΔV) is given by:

$$Δ V = - \frac{eN κ}{ση} \frac{{D}_{d}}{{D}_{w}} Δ P , \qquad ( 3 )$$

where N is the number of mobile ions per unit volume, κ is permeability, η is viscosity, D_{d} is the diffusivity difference of cation (Di⁻) and anion (Di⁺), D_{w} is the diffusivity of water, and ΔP is the applied pressure. The ratio D_{d}/D_{w} is the diffusivity difference normalized to the diffusivity of water, which is to de-embed the effect of water flow in order to focus on the effect of the polymer matrix on diffusivity. When the water flux reaches its maximum (i.e. t=1 ns), PVA-CE predictably produces an amplified and opposite-polarity peak voltage compared to PVA, calculated in equation (3). Ion diffusivity decreases with water flux at the simulation time of 4˜5 ns, the maximum value of D_{d} for PVA is 0.46×10⁻⁵ cm² s⁻¹, which is greater than the value produced initially by pressure. According to Coulomb's law for the electrostatic interaction between charged particles, this secondary potential could be attributed to ionic association driven by coulomb interaction to counteract the potential generated by the net charge imbalance. PVA-CE exhibits a smaller secondary potential, which indicates that the ion association speed is faster than that of PVA.

The faster the ion association, the faster the charge balance, which is predicted that the shorter decay time of the peak voltage. This whole process is analogous to the generation of the liquid junction potential, which is produced by the difference in diffusivity of anions and cations when two electrolytes containing different concentrations of the same ion come into contact with each other. However, the liquid junction potential differs from the piezoionic effect in that the liquid junction potential is derived from a concentration difference, whereas the piezoionic effect is caused by pressure. When ion transport returns to mainly self-diffusion with the water flux diminishing down to zero, corresponding to the simulated period of 10˜20 ns, the system enters a different operation regime. Since the system is still under pressure, ion self-diffusivity expectedly does not return to the initial value at t=0 ns. Overall, results strongly indicate that, due to the ion selective transport from electrostatic interaction, the CE group selectively increases Na⁺ ion diffusivity, which produces an amplified ionic gradient, thereby generating an enhanced voltage response.

### The Pressure-Induced Electrical Response of Piezoionic Devices

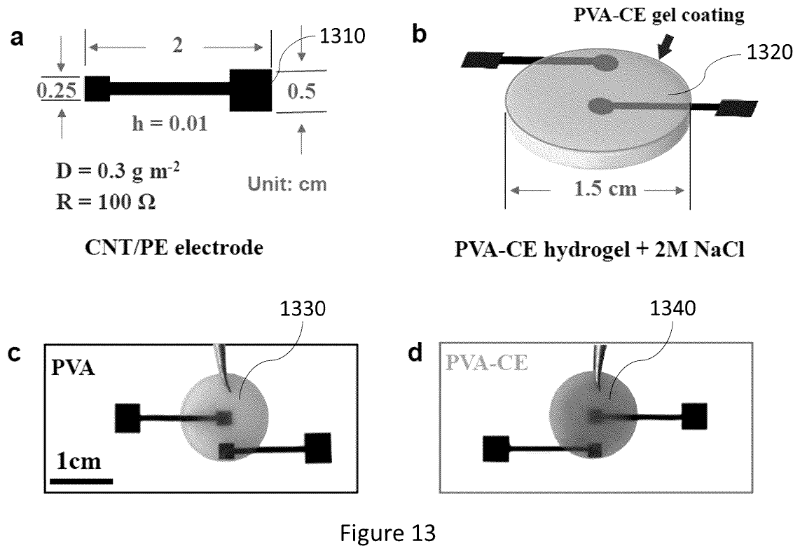

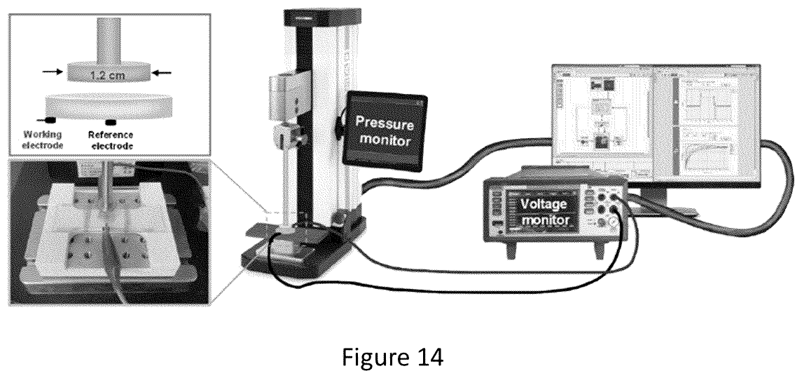

To investigate the effect of piezoionic ion diffusion kinetics on the voltage response, a piezoionic device was assembled. FIG. 13 shows schematic diagrams and photographic representations of an embodiment of an electrode 1310, a PVA-CE sensor 1320, a PVA 1330 and PVA-CE 1340 piezoionic device according to the present invention. Indentation experiment was employed to measure the open circuit voltage between the deformed and undeformed portions of the device. An experimental setup of which is illustrated in FIG. 14.

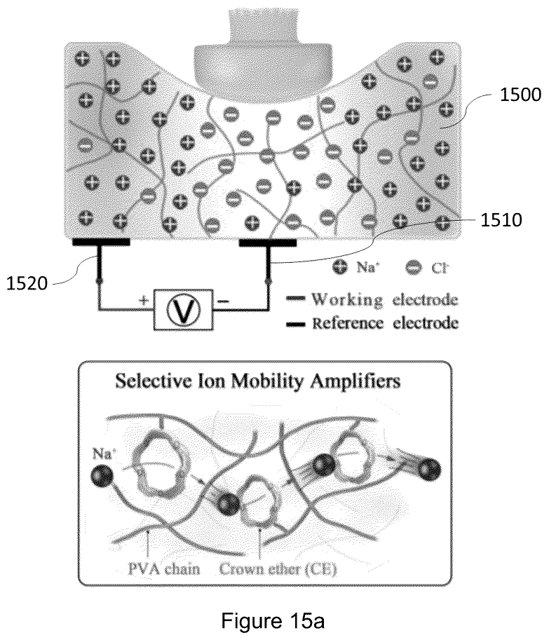

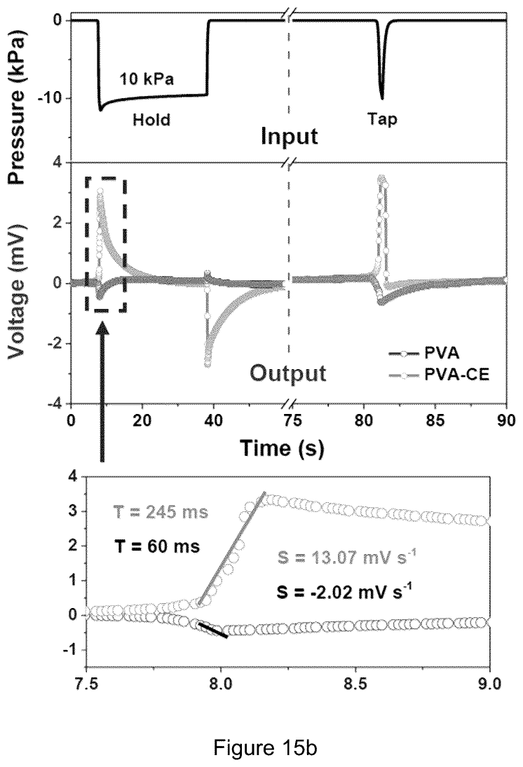

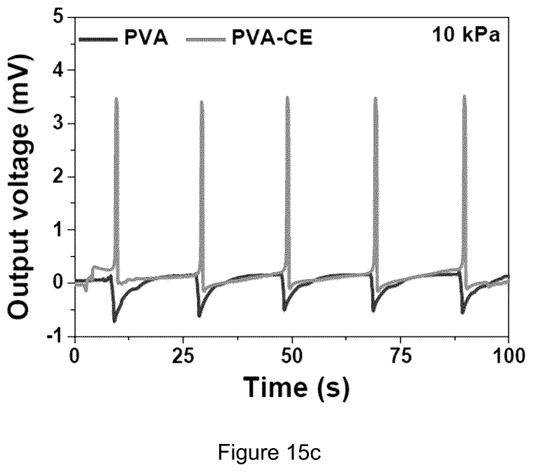

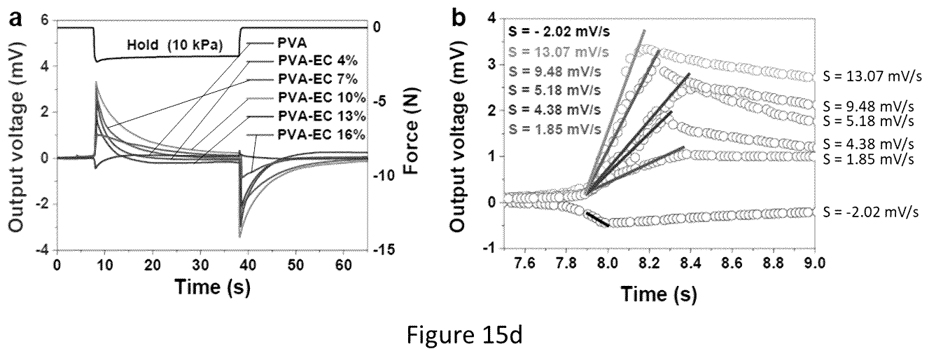

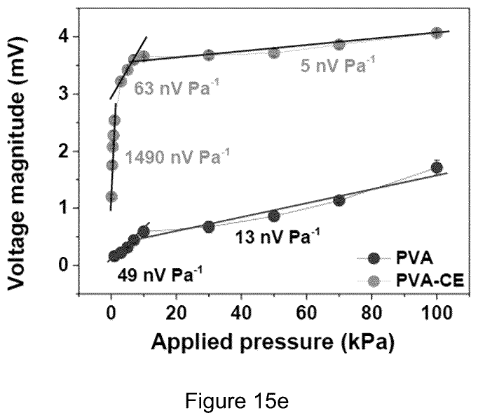

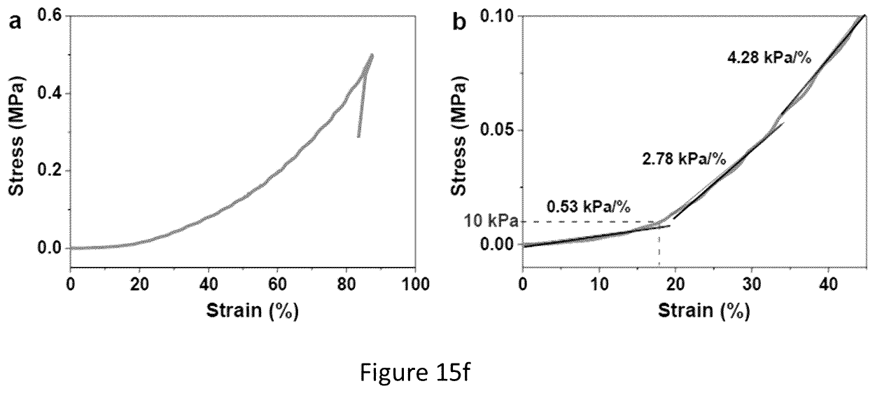

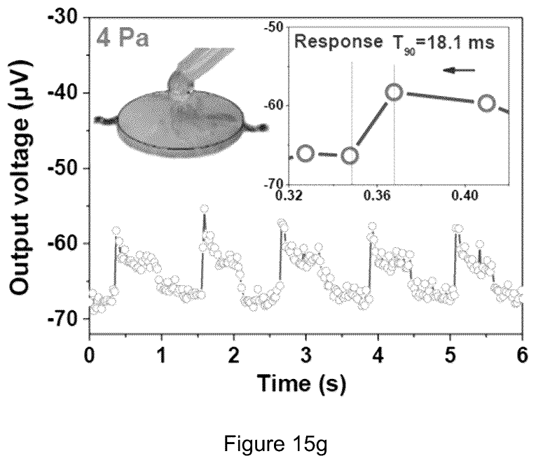

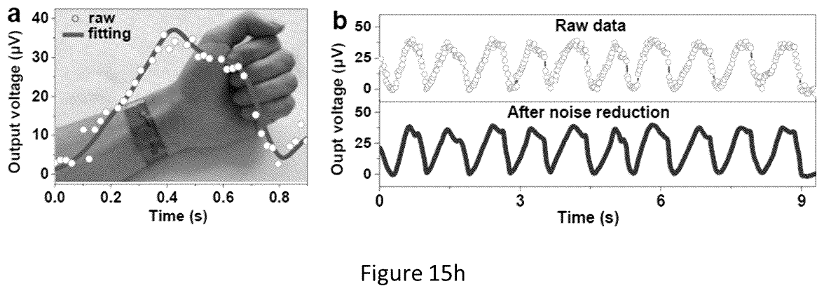

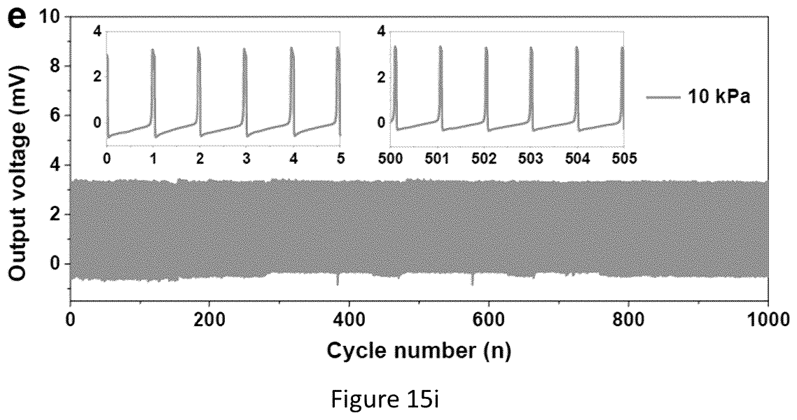

As shown in the illustration of FIG. 15a, each device consists of a reference electrode (RE) 1510, a working electrode (WE) 1520, separated by the PVA-CE hydrogel 1500. RE 1510 and WE 1520 are the positive/sensing and negative/ground electrodes, connected to the negative and positive inputs of a source meter, respectively, When the device is under indentation, CE enhances the transport of Na⁺ ions. This preferential transport of cations (Na⁺) over anions (Cl⁻) amplifies the ionic gradient, resulting in a large positive voltage, as shown in the graphs 15b and 15c which shows the demonstrating step and impulse responses at 10 kPa for PVA and PVA-CE gel, and the corresponding voltage response upon tap compression at 10 kPa.

In this case, two opposite polarity of peak voltage responses upon a step pressure (i.e. applied then held, FIG. 15b, left) of 10 kPa are −0.44 V for the PVA device and 3.06 V for the PVA-CE device, respectively. Upon indenter disengagement after voltage response recover to baseline, the output is sent to the opposite polarity due to opposite ions flux. The PVA and PVA-CE devices output 0.34 V and −2.71 V, respectively. These behaviours are consistent with the aforementioned quantum chemical and electrochemical computations from equation 3. The opposite polarity of the PVA and PVA-CE devices output is due to the different dominant ions, which further demonstrates the selective transport of sodium ions enhanced by CE.

In terms of dynamics, the enlarged view (FIG. 15b, bottom) shows that the voltage rise time for the PVA and PVA-CE devices are 245 ms and 60 ms, respectively. Apparently, since the diffusion of ions is very different from that of electrons thus giving rise to unique device dynamics, the classical definition of rise time used in electronic sensors are no longer applicable or could even be misleading when adopted verbatim to ionic devices.

FIG. 15d provides a more detailed explanation. Therefore, the responsivity, i.e. the slope of the response S=ΔV/ΔT, is adopted to quantify the dynamics of this piezoionic sensor. As shown in the bottom graph of FIG. 15b, the responsivity of PVA-CE (13.07 mV s⁻¹) is nearly folds that of the PVA device (−2.02 mV s⁻¹), which further confirms that CE amplifies the difference in cation/anion transport. Upon a tap motion, i.e. applying a pressure impulse, the peak voltages are −0.62 V and 3.50 V for the PVA and PVA-CE devices, respectively as shown in FIG. 15b, right. The main difference between the pressure impulse and step voltage responses is the recovery time. Under the impulse input, the fall time improves from 2,494 ms of the PVA device to 388 ms of the PVA-CE device. This shows that the ion association speed simulated by quantum chemical are positively related to the recovery time of the peak voltage, and CE also accelerates the recovery process time.

The piezoionic coefficient (α) is the slope of the pressure (ΔP) and output (ΔV) curves of FIG. 15e, i.e.

$$α = - \frac{eN κ}{ση} \frac{{D}_{d}}{{D}_{w}} . \qquad ( Eq . 3 )$$

Under a moderate input of 10 kPa, the difference in a of the two devices narrows to 6 folds. Under a small input of 0-1 kPa, the piezoionic coefficient α of the PVA-CE device is 1490 nV Pa⁻¹, which is 30 times higher than that of PVA (49 nV Pa⁻¹). Importantly, the amplification factor is large under low input levels where it is needed the most in practical applications, as the voltage response is relatively small and prone to degradation from noise. It is also worth recalling that our experimental design purposefully employs crosslinking to standardize the modulus between the PVA and PVA-CE samples to decouple the effect of CE and the effect of mechanical properties (e.g. κ, η) on the piezoionic output. Therefore, the enhancement is, to the first order, the positive effect of EC on the piezoionic mechanism, rather than a change in mechanical property. As is evident from FIG. 15e where the output is plotted across various pressure inputs, the values of α for both PVA and PVA-CE devices decrease rapidly between 10 kPa and 100 kPa, which can be attributed to the nonlinear relationship between the applied pressure and the water flux. Details are shown in the supporting information shown in FIG. 15f. The superior sensitivity of the PVA-CE device in the pressure range within 10 kPa has great potential for application for the neural system. Specifically, the PVA-CE device exhibits a fast piezoionic response for a small drop of water landing on the device, which is equivalent to a pressure of 4 Pa, as shown in FIG. 15g. The sensor exhibits a rise time of 18.1 ms, fall time of 500 ms, and an output of 10.8 μV. The short rise time is unprecedented for a piezoionic device.

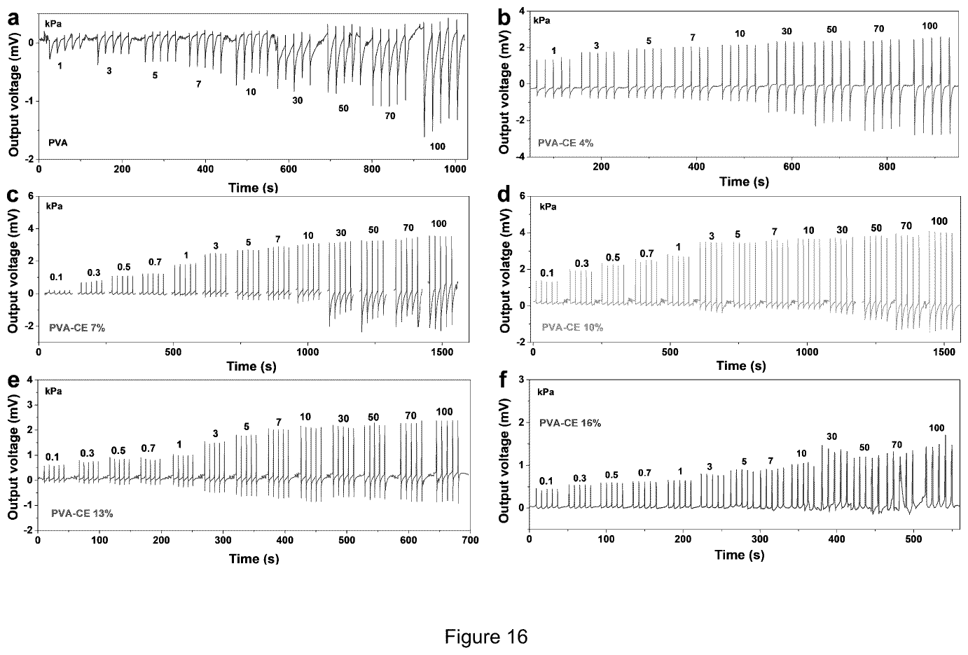

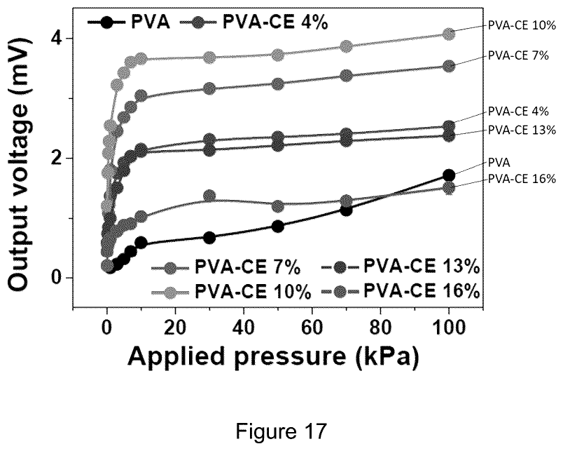

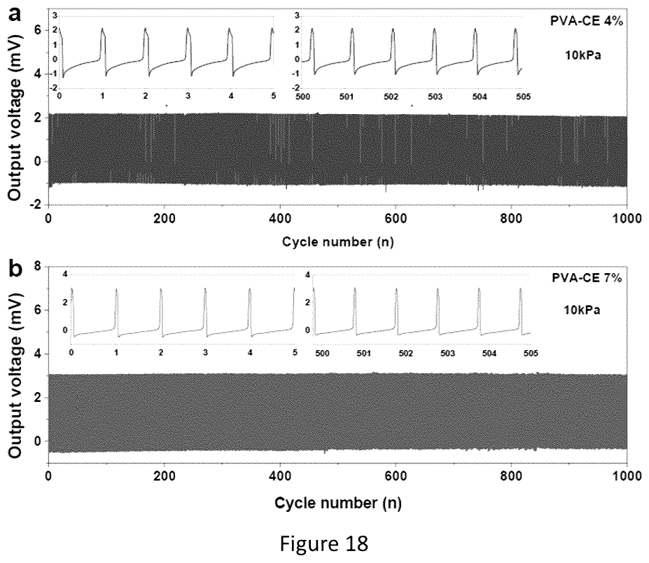

Furthermore, the lowest detection limit is 0.2 Pa, obtained based on the common calculation based on taking one standard deviation of the output noise voltage (±1.3 μV), which is accurate for a device limited by electronic readout noise. This ultra-low detection limit is already lower than a light touch on human skin (≈1 Pa), i.e. this piezoionic is superior to human's Merkel cells. The prototype device has been operated as a pressure sensor in the medical monitoring of a radial artery with pulse features clearly evident, as shown in FIG. 15h. Stability performance of the PVA-CE device under 1,000 load cycles at 10 kPa is shown in FIG. 15i. The PVA-CE device outputs a stable voltage of 3.3 mV, with a<0.1% variation across the entire 1000 cycles. The insets of FIG. 15i present details of cycles 0-6 and 600-606, indicating excellent stability. The effect of the CE content on sensing performance was investigated, as illustrated in FIG. 15d, FIG. 16, FIG. 17 and FIG. 18.

Remarkably, there is an optimal amount of CE content for across all performance metrices, namely peak voltage, responsivity, and piezoionic coefficient. This is attributed to an optimal range of CE between 4-10% that increases the number of effective mobile ions and the diffusivity of Na⁺ under pressure. When CE is increased to an excessive amount (>13%), a large amount of [Na⁺(CE)] complex hinders the diffusion of ions driven by water flow, resulting in a sharp reduction in the number of mobile ions, which has been confirmed by ionic conductivity measurements, as shown in FIG. 7g.

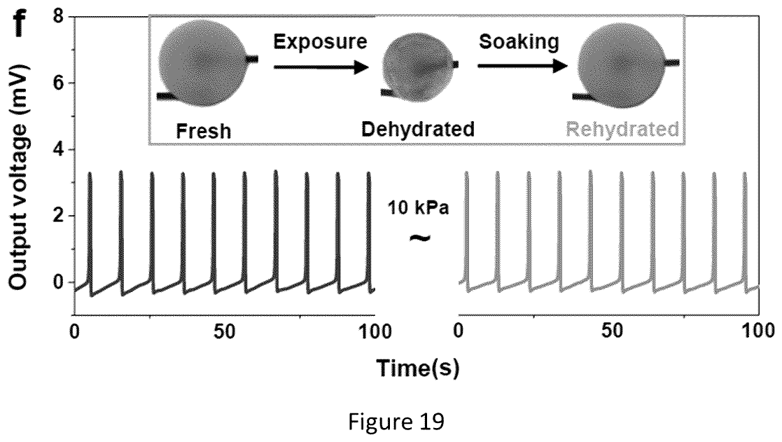

PVA-CE also mitigates the problem of dehydration, which is common to hydrogel sensors, causing baseline drift and shortening lifespan. Due to the reversible coordination bonds introduced by the cross-linker that stabilizes the chemical structure of the PVA-CE hydrogel, it exhibits rehydration shape memory as shown in FIG. 19, which demonstrates the voltage response stability of PVA-CE gel a) with 4% and b) 7% CE contents under cycling test.

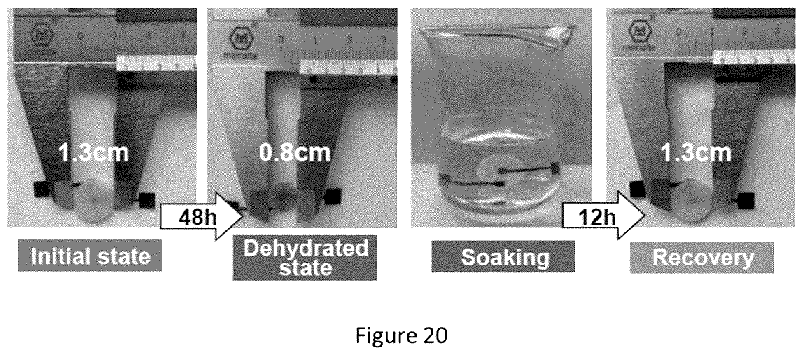

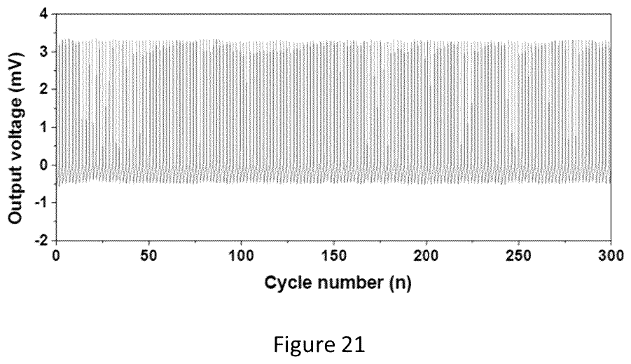

Specifically, a freshly fabricated PVA-CE device initially outputs a voltage of 3.3 mV. After exposing to air for 48 hours, during which time the device lost water as reflected by its diameter reducing from 1.3 cm to 0.8 cm, as in FIG. 20. To restore its shape and function, the device can be soaked in 2M NaCl for 12 h at room temperature, after which its shape completely restores and its diameter fully returns to the original 1.3 cm. Furthermore, the output voltage of the restored device was tested for another 300 cycles without any observable attenuation in output. FIG. 21 shows the cycling voltage response of a PVA-CE gel the piezoionic device after rehydration.

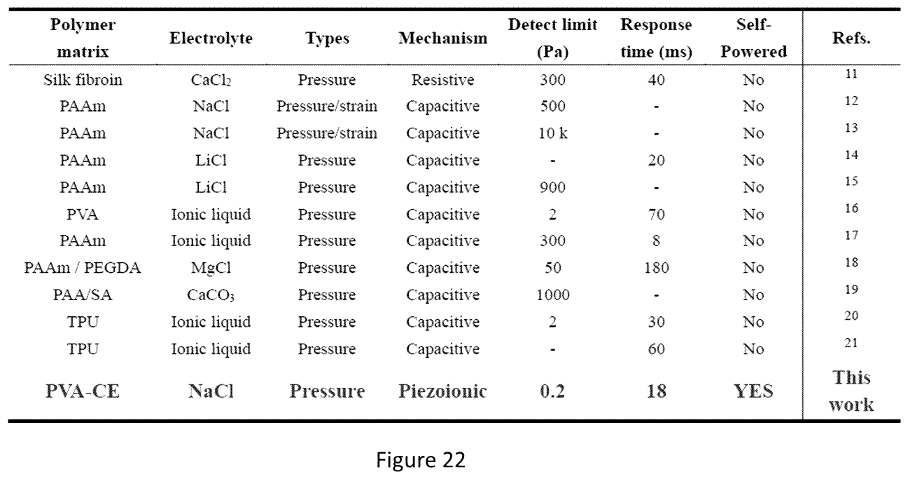

These results suggest that the PVA-CE device exhibits rehydration shape memory, enabling full restoration of performance suitable for long-term operations. Overall, compared to recently reported start-of-the-art ionic mechanical sensors as shown in the table of FIG. 22, the proposed prototype advances performance in terms of both detection limit and response time.

### Application of Piezoionic Skin

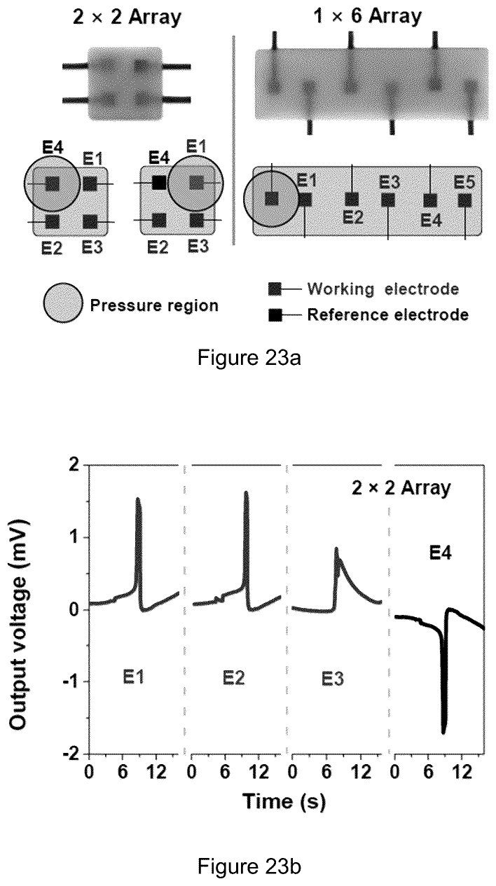

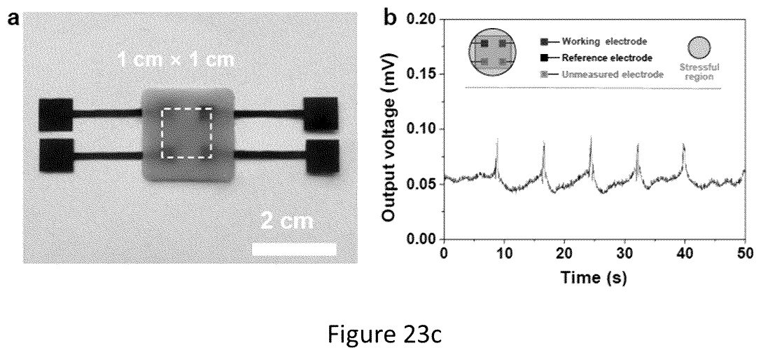

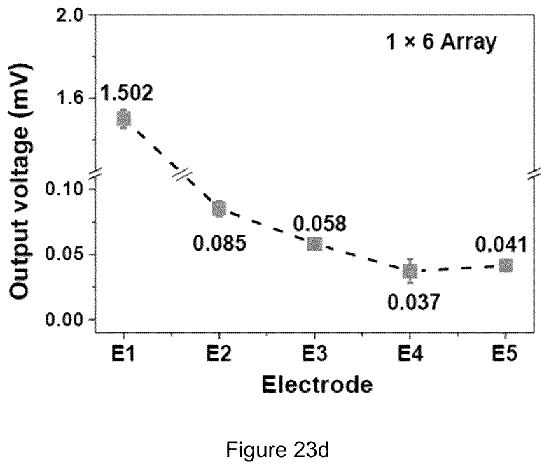

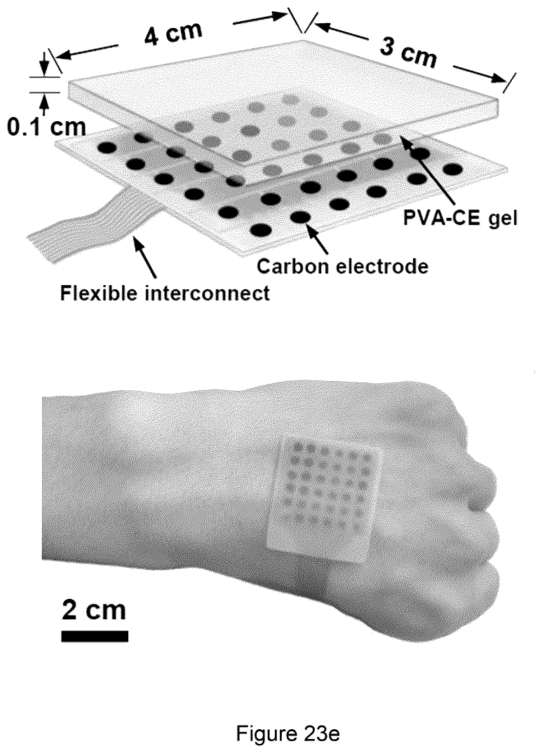

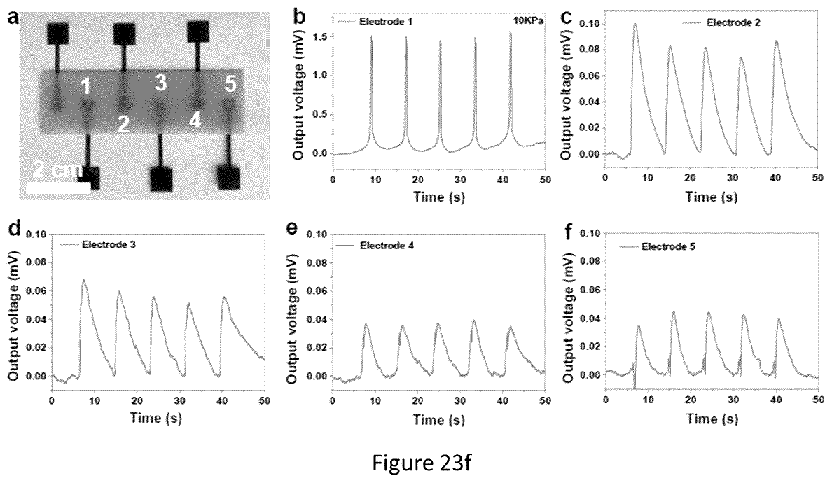

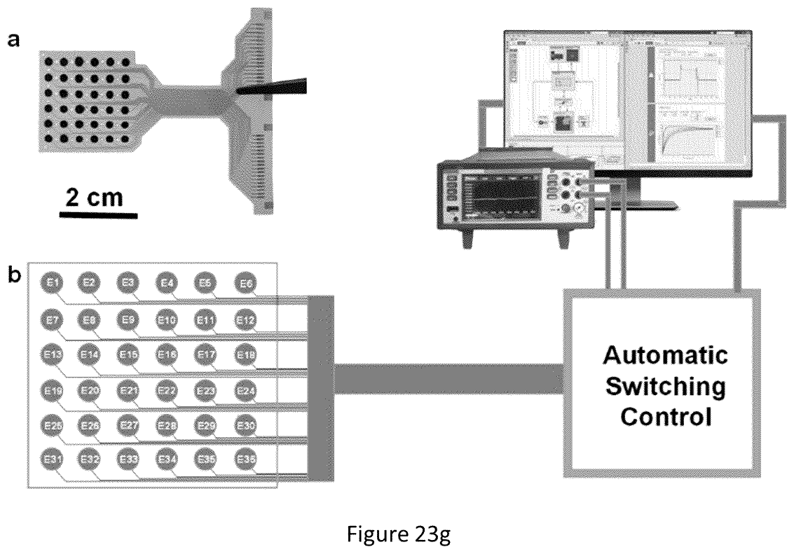

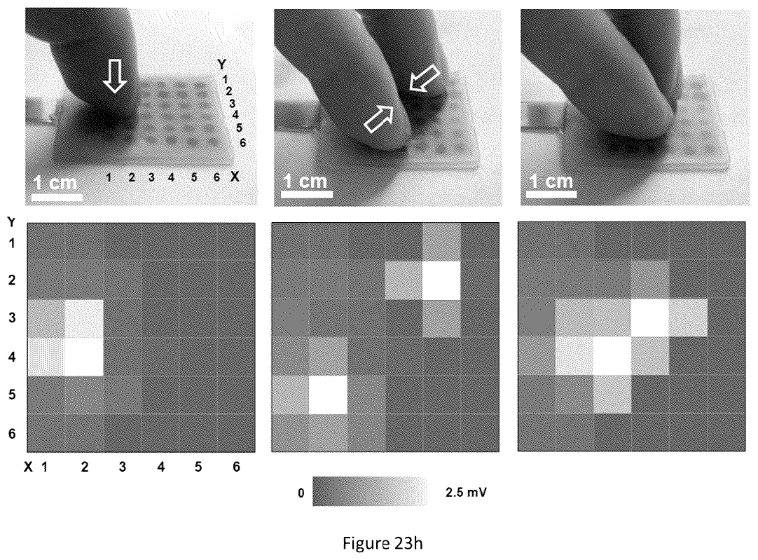

The PVA-CE device is assembled into a pressure sensor array. To assess performance under maximal biocompatibility for potential piezoionic skin application, the array utilizes a NaCl concentration of 0.154 mol L⁻¹, which is the typical ion concentration level of the human somatosensory system. Two configurations of electrodes were tested, namely 2×2 and 1×6, as shown in FIG. 23a. FIG. 23b depicts the output voltage from the 2×2 electrode array. When a pressure of 10 kPa was applied on electrode E4, similar voltage responses of approximately 1.54 mV were measured from E1 and E2, as both electrodes were positioned at equidistant to the applied pressure. E3 showed a reduced voltage (0.77 mV) and a recovery time (>7 s) due to the increased distance. As a control test, when the pressure was applied through a broad area that spans all electrodes, only very weak outputs could be detected at each electrode, as shown in FIG. 23c. FIG. 23d shows results from the 1×6 electrode array. Data shows a non-linear decay of the output voltage (1.50 mV to 0.04 mV) as electrodes are placed further from the pressure region. A schematic diagram and a photographic representation of which are shown in FIG. 23e. Overall, the array response can be described as follows: (1) the largest voltage difference occurs between the pressure centre and the pressure edge, (2) the output voltage is inversely proportional to the distance between the electrodes, and (3) equipotential measured at two points equidistant to the pressure centre reflects the fact that the two points are at the same level on the ionic gradient map.

To assess application potential, a piezoionic skin with 6×6 sensory locations was fabricated using PVA-CE. To output a pressure map, the voltage collected from each electrode are successively readout to a commercial data acquisition module, as shown in FIG. 23f. As shown in FIG. 23g, various motions such as single touch, multiple touches, and the pinch were performed to test the piezoionic skin. For each motion, the corresponding location and output voltage of the PVA-CE piezoionic skin were plotted as a pressure map When multiple touches were combined with the pinch, the direction of motion), and the location of the touch were detected. This precise sensing of touch and analysis of tactile movement are abilities that closely mimic the sensory perception of human skin. The combined capabilities of self-powered, ultra-low detection limit, large-area arrayed implementation, rehydration shape memory, and biocompatibility from the PVA-CE piezoionic skin provide a highly promising route for a variety of advanced and emerging healthcare applications.

An embodiment of present invention provides a strategy for amplifying the piezoionic effect through the ion mobility selectivity provided by crown ether. The strategy has been realized with a CE grafted PVA hydrogel, providing selective Na⁺ transport. Quantum chemistry computations elucidate the exact piezoionic dynamics upon an applied pressure. Experimental results from the PVA-CE piezoionic device show a piezoionic coefficient α=1,490 nV Pa⁻¹ under 1 kPa of pressure which, when compared against the unmodified device, represents a 30-fold piezoionic amplification factor. The device exhibits an ultra-low pressure detection limit of 0.2 Pa with a 18.1 ms ultra-low response time, which is unprecedented for an ionic pressure sensor. The piezoionic skin is capable of generating accurate pressure maps and differentiating between various tactile gestures, biomimicking the human somatosensory system. Piezoionics with desirable characteristics such as high sensitivity, self-power, shape memory, and biocompatibility show great promise for overcoming the grand challenges in synthetic biology, soft robotics, healthcare, and beyond.

### Experiment Details

### a) Materials Characterization

The structure and chemical composition of the polymers were characterized using NMR spectra (Bruker AVANCE IIIT 400HD, 500 MHZ), Fourier transform infrared spectroscopy (FT-IR) (Bruker VECTOR-22, range: 400-4000 cm⁻¹), and X-ray diffraction (XRD) (Bruker discover 8 diffractometer, with Cu Kα radiation with λ=1.5406 Å, scan range: 5-75°). The hydrogels were cut into standard specimens 1.5×5 cm for regular tensile testing with speed of 50 mm/min (Instron model 3382 floor mounted materials testing system). The thickness of the individual specimens was measured with a calliper and was typically around 2 mm. The stress-strain curves were obtained by dividing the measured force by the initial gauge cross-section area and dividing the measured displacement by the initial clamp distance.

### b) Electromechanical Transduction Characterization

A Mark 10 series F+intelliMESUR® advanced tension/compression force testers with force gauge (model M5-5) as a force provider drive an indenter at up to 50 mm/min indentation speed. (experimental setup as depicted in FIG. 14). Regarding the compression stage, after fixing the gel on a glass slide and encapsulating it with a PI elastic film, the CNT/PE electrodes were connected to wires for electrical signal testing. The electrode surface of the gel was placed at the bottom to avoid signal interference caused by electrode vibration and displacement. Samples were indented using a 1 cm diameter cylinder and ensure that the centre of the stressful application region was opposite to the centre electrode of the gel.

Each sample was subjected to a sinusoidal compression to determine the amplitude and the phase of the voltage generated, which was measured with the Keithley DAQ6510 data acquisition/multimeter system. The Mark 10 pressure signal and the Keithley electrical signal were connected to and controlled by a PC using MATLAB software to achieve synchronization of signal acquisition.

### c) Ionic Conductivity Measurement

The ionic conductivity of hydrogel was determined via EIS method under Ti∥ge∥Ti systems. The ionic impedance was determined using an electrochemical workstation (PARSTAT2273) by applying 10 mV AC at 0.1˜1 MHz. All measurements were carried out at room temperature (25° C.). The conductivity, σ, is then determined from the impedance using the equation: σ=L/RA, where L is the thickness of the gel, R is the real part of the impedance, and A is the area of the gel.

### d) Molecular Dynamics Simulation

The partial charge of PVA, PVA-CE molecule was calculated using Gaussian 16 code and the 6-311 g (d,p) basis functions were applied. The OPLSS-AA force field and MKTOP were used to parametrize all atoms, such as the bond parameters, angle parameters and the dihedral angles.

The diffusion coefficients of Na and Cl ions and their coordination models with water molecules in different systems were investigated by molecular dynamics (MD) simulation.

First, the hydrogel model of PVA@NaCl and PVA-CE@NaCl were constructed. In the PVA@NaCl system, 30 PVA, 267 NaCl and 7461 water molecule was were randomly inserted into a cube unit cell with a side length of 7.0 nm. In the PVA-CE@NaCl system, 22 PVA-CE, 267 NaCl and 7461 water molecule was were randomly inserted into a cube unit cell with a side length of 7.0 nm. The MD simulations were performed in the GROMACS 2021 software package. The steepest descent method was applied to minimize the initial energy for each system with a force tolerance of 1 KJ mol⁻¹ nm⁻¹ and a maximum step size of 0.002 ps before MD calculations. In all the three directions, periodic boundary conditions were imposed. Leapfrog algorithm was used to integrate the Newtonian equation of motion. The MD simulation was processed in a constant-pressure, constant-temperature (a.k.a. NPT) ensemble and the simulation time was 20 ns. In NPT simulations, the pressure was maintained at 1 bar by the Berendsen barostat in an isotropic manner. The temperature was maintained by the V-rescale thermostat at 298.15 K. The Particle-Mesh-Ewald (PME) with a fourth-order interpolation was used to evaluate the electrostatic interactions and the grid spacing is 1.0 Å, whereas a cutoff of 1.0 nm was employed to calculate the short-range van der Waals interactions.

For constructing the hydrogel model under the pressure, the hydrogel was instantiated three times along the axial direction, and the time external force was applied to the middle part of the model, the force constant was 1000 KJ mol⁻¹ nm⁻².

An embodiment of the piezoionic device of the present invention achieve the following features:
(i) Self-power generation—e.g. piezoionic devices generates power or does not require an energy source in order to operate.
(ii) When used in the context of sensing, improvement can be realized in terms of sensitivity, speed, stability, dynamic range.
(iii) In the context of a device, capable of outputting an ionic current or voltage, or causes a change in the ion distribution of itself and its neighbouring environment.
(iv) Devices can be made to be soft and stretchable. Some could be stretched to 15 times its original length.
(v) Devices can be made biocompatible, capable of being implanted and attached to skin without significant irritation and/or harm to the body.

What is claimed is:

1. A piezoionic device for providing an electrical signal, wherein the device comprising:
(i) a matrix comprising a plurality of mobile cations and anions,
(ii) two electrodes in contact with the matrix, configured to provide the electrical signal in response to an external pressure applied to the matrix depending on a mobility difference between the cations and the anions,
wherein the matrix further comprises a selective ion mobility amplifier, for selectively enhancing or hindering diffusivity of either the cations or the anions, thereby increasing the mobility difference which amplifies the electrical signal.

2. The device according to claim 1, wherein the selective ion mobility amplifier is crown ether.

3. The device according to claim 2, wherein the crown ether is formed with Diethylene glycol bis(2-chloroethyl) ether (DGBE), Sodium Hydroxide (NaOH) and Ethyl 3,4-dihydroxybenzoate (EDB).

4. The device according to claim 3, wherein monomers of the Diethylene glycol bis(2-chloroethyl) ether (DGBE), the Sodium Hydroxide (NaOH) and the Ethyl 3,4-dihydroxybenzoate (EDB) are with molar ratio of 1:2:1.

5. The device according to claim 1, wherein the matrix comprises a composite selected from polyurethane (PU), polyvinylidene difluoride (PVDF), polydimethylsiloxane (PDMS), Polyvinyl alcohol (PVA), Polyacrylamide (PAM), rubber, cellulose, or a combination thereof.

6. The device according to claim 5, wherein the composite is polyvinyl alcohol (PVA), and the matrix is formed with a crown ether grafted polyvinyl alcohol polymer (PVA-CE).

7. The device according to claim 6, wherein the polyvinyl alcohol (PVA) and the crown ether are with a molar ratio of 1:(0.05-0.15).

8. The device according to claim 6, wherein the matrix is in a form of a hydrogel.

9. The device according to claim 6, wherein the matrix is stretchable to 15 times its original length.

10. The device according to claim 1, wherein the electrodes comprise a polymer and an electrically conductive material.

11. The device according to claim 10, wherein the polymer is polyethylene polyimide; the electrically conductive material is a metal or a carbon material.

12. The device according to claim 11, wherein the metal is selected from any one of copper, gold, silver, platinum or a combination thereof; the carbon material is selected from any one of carbon nanotube, carbon black, graphene or a combination thereof.

13. The device according to claim 10, wherein the electrodes are with a resistance of 100Ω and a density of 0.3 g cm⁻².

14. The device according to claim 1, configured to provide the electrical signal in response to the external pressure as low as 0.2 Pa.

15. The device according to claim 1, configured to provide the electrical signal with a response time of 18.1 ms in response to the external pressure.

16. The device according to claim 1, wherein the matrix is biocompatible.

17. A pressure sensor comprising the piezoionic device as claimed in claim 1, configured for detection of a magnitude of external pressure applied to the piezoionic device, wherein the piezoionic device comprising a plurality of electrodes aligned in an array arrangement.

18. An energy harvesting device comprising the piezoionic device as claimed in claim 1, configured to convert an external mechanical energy applied to the piezoionic device into electrical energy, wherein the piezoionic device comprising a plurality of electrodes aligned in an array arrangement.

19. A sensor skin comprising the piezoionic device as claimed in claim 1,
wherein the piezoionic device comprises a plurality of electrodes aligned across the matrix, configured for providing a plurality of electrical signals at respective positions of the matrix in response to an external pressure applied to the respective positions,
wherein the plurality of electrical signals are mapped to indicate a planar pressure change across the matrix.

20. The sensor skin according to claim 19, wherein the plurality of electrodes are aligned in an array across the matrix.
